(19) United States
(12) Patent Application Publication
(10) Pub. No.: US 2026/0072124 A1
(43) Pub. Date: Mar. 12, 2026

(54) METHODS, APPARATUS, AND ARTICLES OF MANUFACTURE TO MITIGATE INTERFERENCE IN DOPPLER-RANGE REPRESENTATIONS

(71) Applicant: Texas Instruments Incorporated, Dallas, TX (US)

(72) Inventors: Sandeep Rao, Bangalore (IN); Yash Sharma, Jaipur (IN); Karthik Subburaj, Bangalore (IN)

(21) Appl. No.: 19/198,761

(22) Filed: May 5, 2025

(30) Foreign Application Priority Data
Sep. 6, 2024 (IN) 202441067446

(51) Int. Cl. G01S 7/02; G01S 13/58

(52) U.S. Cl. CPC G01S 7/023; G01S 13/583

(57) ABSTRACT

An example apparatus includes interface circuitry to receive digital samples representative of a frame of chirps. The apparatus includes programmable circuitry, which may be programmed by instructions, to: for a range Fourier transform (FT) representation of the frame of chirps, determine a reconstructed chirp for a chirp of the frame of chirps that includes a corrupted sample; determine a first Doppler-range representation of the frame of chirps based on the range FT representation, the range FT representation including the reconstructed chirp; and determine a second Doppler-range representation as an element-wise minimum between the first Doppler-range representation and a third Doppler-range representation of the frame of chirps, the third Doppler-range representation based on the digital samples, the digital samples including a reconstructed sample substituted for the corrupted sample of the chirp. Other examples are described.

### CROSS-REFERENCE TO RELATED APPLICATION

This patent application claims the benefit of and priority to Indian Provisional Patent Application No. 202441067446, filed Sep. 6, 2024, which Application is hereby incorporated herein by reference in its entirety.

### TECHNICAL FIELD

This description relates generally to Doppler-division multiple-access radar and, more particularly, to methods, apparatus, and articles of manufacture to mitigate interference in doppler-range representations.

### BACKGROUND

Doppler division multiple-access (DDMA) is a method of dividing a Doppler dimension or Doppler domain into multiple sub-divisions and assigning a transmitter to one sub-division. This may be performed by generating a sequence of chirps such that there is a linear increment (or decrement) in the starting phase of each chirp. Different transmitters may have different rates of phase increment or decrement. For each chirp, multiple transmitters are enabled. When received and processed according to a two-dimensional fast Fourier transform (FFT), DDMA signals from different transmitters will each occupy a different band in the Doppler domain. In this way, DDMA facilitates the simultaneous use of multiple transmitters within a single chirp while preventing the multiple transmitters from interfering with each other in the Doppler domain, also providing a capability to separate data from each transmitter.

### SUMMARY

For methods, apparatus, and articles of manufacture to mitigate interference in Doppler-range representations, an example apparatus includes interface circuitry to receive digital samples representative of a frame of chirps. The apparatus includes programmable circuitry to: for a range Fourier transform (FT) representation of the frame of chirps, determine a reconstructed chirp for a chirp of the frame of chirps that includes a corrupted sample; determine a first Doppler-range representation of the frame of chirps based on the range FT representation, the range FT representation including the reconstructed chirp; and determine a second Doppler-range representation as an element-wise minimum between the first Doppler-range representation and a third Doppler-range representation of the frame of chirps, the third Doppler-range representation based on the digital samples, the digital samples including a reconstructed sample substituted for the corrupted sample of the chirp. The programmable circuitry may be one or more programmable circuits, which may be programmed by instructions. Other examples are described.

For methods, apparatus, and articles of manufacture to mitigate interference in Doppler-range representations, an example non-transitory computer-readable medium includes instructions to cause programmable circuitry to, for a range Fourier transform (FT) representation of a frame of chirps, determine a reconstructed chirp for a chirp of the frame of chirps that includes a corrupted sample, the frame of chirps received from an environment by a radar integrated circuit and represented by digital samples. The non-transitory computer-readable medium includes instructions to cause programmable circuitry to determine a first Doppler-range representation of the frame of chirps based on the range FT representation, the range FT representation including the reconstructed chirp. The non-transitory computer-readable medium includes instructions to cause programmable circuitry to determine a second Doppler-range representation as an element-wise minimum between the first Doppler-range representation and a third Doppler-range representation of the frame of chirps, the third Doppler-range representation based on the digital samples, the digital samples including a reconstructed sample substituted for the corrupted sample of the chirp. The programmable circuitry may be one or more programmable circuits, which may be programmed by instructions. Other examples are described.

For methods, apparatus, and articles of manufacture to mitigate interference in Doppler-range representations, an example method includes receiving, with interface circuitry, digital samples representative of a frame of chirps. The method includes replacing, by executing an instruction with programmable circuitry, a chirp of the frame of chirps that includes a corrupted sample with a zero-value chirp in the digital samples. The method includes determining, by executing an instruction with the programmable circuitry, a range Fourier transform (FT) representation of the frame of chirps based on the digital samples, the digital samples including the zero-value chirp, the range FT representation having a first dimension and a second dimension. The method includes for respective indices across the second dimension of the range FT representation, determining, by executing an instructions with the programmable circuitry, a Doppler FT representation. The method includes for respective Doppler FT representations: setting, by executing an instruction with the programmable circuitry, a value that does not satisfy a threshold of a peak value in the respective Doppler FT representations to zero; and determining, by executing an instruction with the programmable circuitry, an inverse range FT representation to generate a reconstructed chirp. The method includes replacing, by executing an instruction with the programmable circuitry, the chirp including the corrupted sample in the range FT representation with the reconstructed chirp. The method includes determining, by executing an instruction with the programmable circuitry, a Doppler-range representation of the frame of chirps based on the range FT representation, the range FT representation including the reconstructed chirp. The programmable circuitry may be one or more programmable circuits, which may be programmed by instructions. Other examples are described.

### BRIEF DESCRIPTION OF THE DRAWINGS

FIG. 1 is a block diagram of an example radar system including example radar circuits.

FIG. 2 is a block diagram of an example radar transceiver integrated circuit (IC) that can implement any of the radar circuits of FIG. 1.

FIG. 3A is a timing diagram of an example frame of example chirps.

FIG. 3B is a diagram of an example processing flow to generate an example Doppler-range representation of a received frame of reflected chirps.

FIG. 4A is a timing diagram of interference that can occur in radar applications.

FIG. 4B is a graphical illustration of digital samples corresponding to the timing diagram of FIG. 4A.

FIG. 5 is a diagram of an example processing flow to generate a first example Doppler-range representation of a received frame of reflected chirps to mitigate interference along a range dimension.

FIG. 6 is a diagram of an example processing flow to generate a second example Doppler-range representation of the received frame of reflected chirps to mitigate interference along a Doppler dimension.

FIG. 7 is a diagram of an example processing flow to generate a third example Doppler-range representation of the received frame of reflected chirps to mitigate interference along the range dimension and the Doppler dimension.

FIG. 8 is a diagram of an example processing flow to reconstruct corrupted ADC samples along the range dimension and the Doppler dimension.

FIG. 9 is a flowchart representative of example machine-readable instructions or example operations that may be at least one of executed, instantiated, or performed using an example programmable circuitry implementation of the radar transceiver IC of FIG. 2 to determine a Doppler-range representation to mitigate interference along the range dimension and the Doppler dimension.

FIG. 10 is a flowchart representative of example machine-readable instructions or example operations that may be at least one of executed, instantiated, or performed using an example programmable circuitry implementation of the radar transceiver IC of FIG. 2 to determine a reconstructed chirp for a reflected chirp including a corrupted sample.

FIG. 11 is a flowchart representative of example machine-readable instructions or example operations that may be at least one of executed, instantiated, or performed using an example programmable circuitry implementation of the radar transceiver IC of FIG. 2 to determine a Doppler-range representation to mitigate interference along the range dimension and the Doppler dimension.

FIG. 12 is a block diagram of an example processing platform including programmable circuitry structured to execute, instantiate, or perform the example machine-readable instructions or perform the example operations of FIGS. 9, 10, and 11 to implement the radar transceiver IC of FIG. 2.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, or firmware (e.g., corresponding to the example machine-readable instructions of FIGS. 9, 10, and 11) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The drawings are not necessarily to scale. Generally, the same reference numbers in the drawing(s) and this description refer to the same or similar (in terms of at least one of functional or structural) features or parts. Although the drawings show regions with clean lines and boundaries, some or all of these lines and boundaries may be idealized. In reality, the boundaries or lines may be unobservable, blended or irregular.

### DETAILED DESCRIPTION

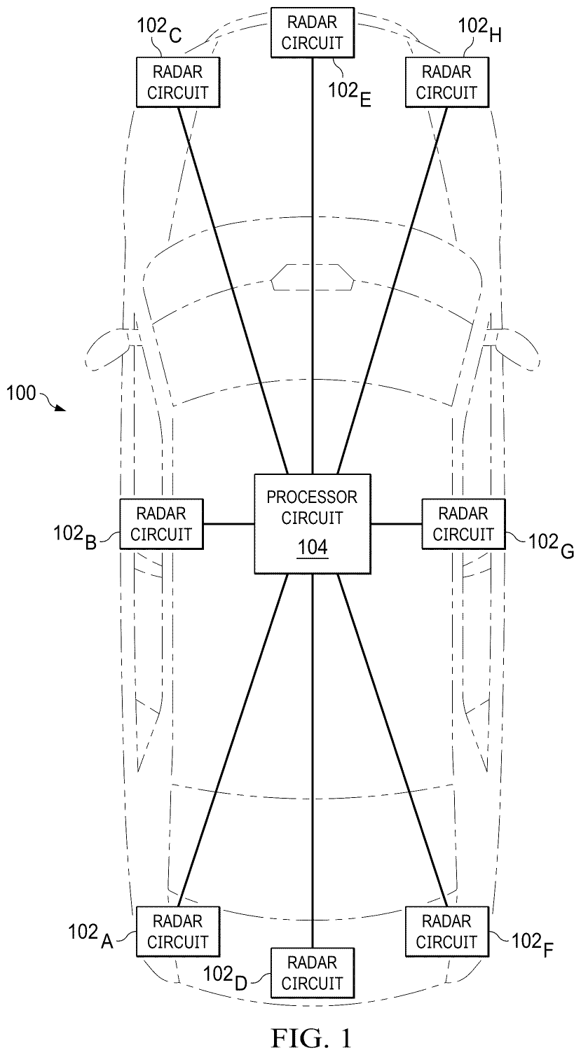

FIG. 1 is a block diagram of an example radar system 100 including example radar circuits 102_{A}, 102_{B}, 102_{C}, 102_{D}, 102_{E}, 102_{F}, 102_{G}, 102_{H}. In the example of FIG. 1, the radar system 100 also includes an example processor circuit 104. In the example of FIG. 1, one or more of the radar circuits 102_{A}, 102_{B}, 102_{C}, 102_{D}, 102_{E}, 102_{F}, 102_{G}, 102_{H} may be referred to as a radar front end and the processor circuit 104 may be referred to as a radar backend. In some examples, one or more of the radar circuits 102_{A}, 102_{B}, 102_{C}, 102_{D}, 102_{E}, 102_{F}, 102_{G}, 102_{H} and the processor circuit 104 are implemented separately and may be adapted to be coupled together. Also or alternatively, one or more of the radar circuits 102_{A}, 102_{B}, 102_{C}, 102_{D}, 102_{E}, 102_{F}, 102_{G}, 102_{H} is implemented with an instance of the processor circuit 104, for example, in a single chip package or on a system-on-chip (SoC) (e.g., a single IC). In examples in which one or more of the radar circuits 102_{A}, 102_{B}, 102_{C}, 102_{D}, 102_{E}, 102_{F}, 102_{G}, 102_{H} are implemented with an instance of the processor circuit 104 on a SoC, the one or more of the radar circuits 102_{A}, 102_{B}, 102_{C}, 102_{D}, 102_{E}, 102_{F}, 102_{G}, 102_{H} may correspond to a sub-circuit of the IC that forms the SoC.

In the illustrated example of FIG. 1, the processor circuit 104 is coupled to each of the radar circuits 102_{A}, 102_{B}, 102_{C}, 102_{D}, 102_{E}, 102_{F}, 102_{G}, 102_{H} (e.g., via an interface) that may facilitate any suitable communication technique (e.g., a serial interface, a parallel interface, etc.) and is structured to at least one of receive data from or transmit data to each of the radar circuits 102_{A}, 102_{B}, 102_{C}, 102_{D}, 102_{E}, 102_{F}, 102_{G}, 102_{H}. In some examples, the interface between the processor circuit 104 and each of the radar circuits 102_{A}, 102_{B}, 102_{C}, 102_{D}, 102_{E}, 102_{F}, 102_{G}, 102_{H} may be a high-speed serial interface such as a low-voltage differential signaling (LVDS) interface. Also or alternatively, the interface between the processor circuit 104 and each of the radar circuits 102_{A}, 102_{B}, 102_{C}, 102_{D}, 102_{E}, 102_{F}, 102_{G}, 102_{H} may be a lower speed interface such as a serial peripheral interface (SPI).

In the illustrated example of FIG. 1, one or more of the radar circuits 102_{A}, 102_{B}, 102_{C}, 102_{D}, 102_{H}, 102_{F}, 102_{G}, 102_{H} can implement DDMA as described herein. For example, one or more of the radar circuits 102_{A}, 102_{B}, 102_{C}, 102_{D}, 102_{E}, 102_{F}, 102_{G}, 102_{H} can generate, and transmit into an environment, a sequence of chirps, sometimes referred to as a frame of chirps, such that there is a linear increment (or decrement) in the starting phase of each chirp. In the example of FIG. 1, one or more of the radar circuits 102_{A}, 102_{B}, 102_{C}, 102_{D}, 102_{E}, 102_{F}, 102_{G}, 102_{H} includes functionality to generate one or more chirp signals as described herein. Also, each of the radar circuits 102_{A}, 102_{B}, 102_{C}, 102_{D}, 102_{E}, 102_{F}, 102_{G}, 102_{H} also includes functionality to generate one or more digital intermediate frequency (IF) signals (sometimes referred to as de-chirped signals, beat signals, or raw radar signals) from reflected chirps.

In the illustrated example of FIG. 1, each of the radar circuits 102_{A}, 102_{B}, 102_{C}, 102_{D}, 102_{E}, 102_{F}, 102_{G}, 102_{H} includes functionality to perform at least a portion of signal processing of received radar signals (e.g., the reflected chirps, the digital IF signals, etc.), and to provide the results of the signal processing to the processor circuit 104. In some examples, each of the radar circuits 102_{A}, 102_{B}, 102_{C}, 102_{D}, 102_{E}, 102_{F}, 102_{G}, 102_{H} includes functionality to perform a range Fourier transform (FT) for each received frame (e.g., each sequence of chirps of the frame). Also or alternatively, each of the radar circuits 102_{A}, 102_{B}, 102_{C}, 102_{D}, 102_{E}, 102_{F}, 102_{G}, 102_{H} includes functionality to perform a Doppler FT for each received frame (e.g., after performing, and on a result of, the range FTs). In some examples provided herein, one or both of the range FT and Doppler FT may be a range fast Fourier transform (FFT) and/or a Doppler FFT.

In the illustrated example of FIG. 1, the processor circuit 104 includes functionality to process data received from one or more of the radar circuits 102_{A}, 102_{B}, 102_{C}, 102_{D}, 102_{E}, 102_{F}, 102_{G}, 102_{H} to, for example, determine one or more of a distance, velocity, or angle of any objects detected by the radar system 100. Also or alternatively, the processor circuit 104 includes functionality to perform post processing of information concerning the detected objects, such as tracking objects or determining rate and direction of movement. In some examples, the processor circuit 104 performs at least one of velocity disambiguation or collision detection.

In the illustrated example of FIG. 1, the processor circuit 104 includes one or more processors or combinations of processors for processing data received from one or more of the radar circuits 102_{A}, 102_{B}, 102_{C}, 102_{D}, 102_{E}, 102_{F}, 102_{G}, 102_{H}. In the example of FIG. 1, the processor circuit 104 also provides data to one or more of the radar circuits 102_{A}, 102_{B}, 102_{C}, 102_{D}, 102_{E}, 102_{F}, 102_{G}, 102_{H}. For example, the processor circuit 104 may include one or more of a digital signal processor (DSP), a microcontroller, a SoC combining both a DSP and a microcontroller, a field-programmable gate array (FPGA), or any combination of the foregoing.

In the illustrated example of FIG. 1, the radar system 100 can be implemented in a variety of applications such as advanced driver assistance systems (ADAS) and automotive vehicles to measure distance, velocity, acceleration, and angle. In some examples, the radar system 100 can be implemented in other vehicles (e.g., aircraft or marine), industrial use-cases, imaging radar, robotics, automation (e.g., industrial automation, building automation, etc.), security and surveillance (e.g., building security), people counting, or medical devices for blood pressure monitoring, emotional monitoring, and sleep monitoring. In the example of FIG. 1, the radar system 100 is implemented in an example automotive application. For example, the radar circuits 102_{A}, 102_{B}, 102_{C}, 102_{D}, 102_{E}, 102_{F}, 102_{G}, 102_{H} are positioned around a vehicle to provide automotive driver assistance. FIG. 1 shows an example use-case with eight radar circuits, while some vehicles may have only corner radar circuits 102_{A}, 102_{C}, 102_{F}, 102_{H} or front radar circuit 102_{E}.

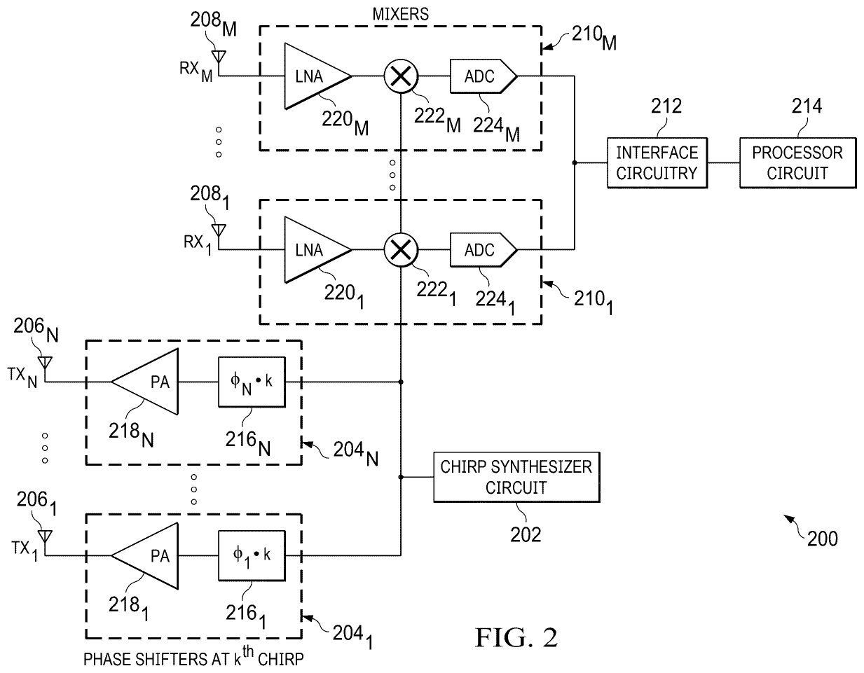

FIG. 2 is a block diagram of an example radar transceiver integrated circuit (IC) 200 that can implement any of the radar circuits 102_{A}, 102_{B}, 102_{C}, 102_{D}, 102_{E}, 102_{F}, 102_{G}, 102_{H} of FIG. 1. In the example of FIG. 2, the radar transceiver IC 200, a radar integrated circuit, includes an example chirp synthesizer circuit 202, example transmitters 204₁-204_{N}, example transmit antennas 206₁-206_{N}, example receive antennas 208₁-208_{M}, example receivers 210₁-210_{M}, example interface circuitry 212, and an example processor circuit 214. Also, in the example of FIG. 2, the transmitters 204₁-204_{N} include example phase shifters 216₁-216_{N} and example power amplifiers (PAS) 218₁-218_{N}, respectively.

In the illustrated example of FIG. 2, the receivers 210₁-210_{M} include example low noise amplifiers (LNAs) 220₁-220_{M}, example mixers 222₁-222_{M}, and example analog-to-digital converters (ADCs) 224₁-224_{M}, respectively. In the example of FIG. 2, the radar transceiver IC 200 includes four of each of the transmitters 204₁-204_{N}, the transmit antennas 206₁-206_{N}, the receive antennas 208₁-208_{M}, and the receivers 210₁-210_{M} (e.g., N equals M equals four). In some examples, the radar transceiver IC 200 includes a different numbers of any of the transmitters 204₁-204_{N}, the transmit antennas 206₁-206_{N}, the receive antennas 208₁-208_{M}, or the receivers 210₁-210_{M}.

In some examples, the radar transceiver IC 200 and the processor circuit 214 are implemented separately and may be adapted to be coupled together. Also or alternatively, the radar transceiver IC 200 is implemented with the processor circuit 214, for example, in a single chip package or on a SoC (e.g., a single IC). In examples where the radar transceiver IC 200 is implemented with the processor circuit 214 on a SoC, the radar transceiver IC 200 may correspond to a sub-circuit of the IC that forms the SoC.

In the illustrated example of FIG. 2, the chirp synthesizer circuit 202 is implemented by at least one of analog or digital circuitry. In the example of FIG. 2, the chirp synthesizer circuit 202 is coupled to the transmitters 204₁-204_{N}. For example, the chirp synthesizer circuit 202 is coupled to the phase shifters 216₁-216_{N} of the transmitters 204₁-204_{N}. Also, in the example of FIG. 2, the chirp synthesizer circuit 202 is coupled to the receivers 210₁-210_{M}. For example, the chirp synthesizer circuit 202 is coupled to the mixers 222₁-222_{M} of the receivers 210₁-210_{M}. In some examples, the chirp synthesizer circuit 202 is coupled to the processor circuit 214.

In the illustrated example of FIG. 2, each of the phase shifters 216₁-216_{N} is implemented by at least one of analog or digital circuitry. In the example of FIG. 2, each of the phase shifters 216₁-216_{N} is coupled to the chirp synthesizer circuit 202. Also, in the example of FIG. 2, the phase shifters 216₁-216_{N} are coupled to the PAs 218₁-218_{N} (e.g., respective phase shifters are coupled to respective PAs). In the example of FIG. 2, each of the PAs 218₁-218_{N} is implemented by at least one of analog or digital circuitry. Also, in the example of FIG. 2, the PAS 218₁-218_{N} are coupled to the phase shifters 216₁-216_{N} and the transmit antennas 206₁-206_{N}.

In modern applications, radar circuits, such as the radar transceiver IC 200 of FIG. 2, include multiple transmitters and multiple receivers. DDMA provides a method to divide a Doppler domain spectrum into multiple sub-divisions and assign each of the multiple transmitters to a respective sub-division. For example, DDMA is widely used in automotive frequency modulated continuous wave (FMCW) radar applications. In DDMA, multiple transmitters transmit a frame of chirps simultaneously where each transmitter imparts a linear phase change (Φ) across the chirps of the frame. For the kth indexed transmitter, Φₖ=2πk/N_{TX} where N_{TX} is the number of transmitters and k is an index value in a range of [1:N] corresponding to a transmitter that will be transmitting a signal with a phase change Φₖ. As such, the phase changes for the N_{TX} transmitters increase linearly with a direct proportionality to transmitter indices. DDMA results in the Doppler domain spectrum that is divided into N_{TX} bands where each target detected by a radar circuit results in N_{TX} peaks or representations and each peak (e.g., image) corresponds to one of the N_{TX} transmitters.

In the illustrated example of FIG. 2, the radar transceiver IC 200 implements DDMA. For example, the chirp synthesizer circuit 202 includes functionality to receive chirp parameter values (e.g., from the processor circuit 214) for a sequence of chirps in a radar frame. In some examples, the chirp parameters are defined by the radar system architecture and may include, for example, a transmitter enable parameter for indicating which of the transmitters 204₁-204_{N} to enable, a chirp frequency start value, a chirp frequency slope, an ADC sampling time, a ramp end time, and a transmitter start time, among others. In the example of FIG. 2, the chirp synthesizer circuit 202 also includes functionality to generate signals (e.g., a chirp, a frame of chirps, etc.) for transmission based on the chirp parameter values (e.g., received from the processor circuit 214). In some examples, the chirp synthesizer circuit 202 includes a phase locked loop (PLL) oscillator with a voltage-controlled oscillator (VCO). In additional or alternative examples, the chirp synthesizer circuit 202 includes a local oscillator (LO).

In the illustrated example of FIG. 2, each of the phase shifters 216₁-216_{N} receives the output signal provided by the chirp synthesizer circuit 202 (e.g., a chirp, a frame of chirps, etc.) and modulates the output signal provided by the chirp synthesizer circuit 202 to generate a frame of chirps having a linear phase change across chirps. For example, for a first example indexed transmitter 204₁, a first example indexed phase shifter 216₁ applies a first phase change Φ₁ between consecutive chirps of a frame. As such, the first indexed phase shifter 216₁ generates a frame of chirps where the phase changes between consecutive chirps of the frame are equal (e.g., for TX₁ ΔΦ_{C1-C2}=ΔΦ_{C2-C3}=ΔΦ_{C3-C4} . . . =ΔΦ_{C(N-1)-CN}). Also, for example, for an Nth example indexed transmitter 204_{N}, an Nth example indexed phase shifter 216_{N} applies a Nth phase change Φ_{N} between consecutive chirps of a frame. As such, the Nth indexed phase shifter 216_{N} generates a frame of chirps where the phase changes between consecutive chirps of the frame are equal (e.g., for TX_{N} ΔΦ_{C1-C2}=ΔΦ_{C2-C3}=ΔΦ_{C3-C4} . . . =ΔΦ_{C(N-1)-CN}).

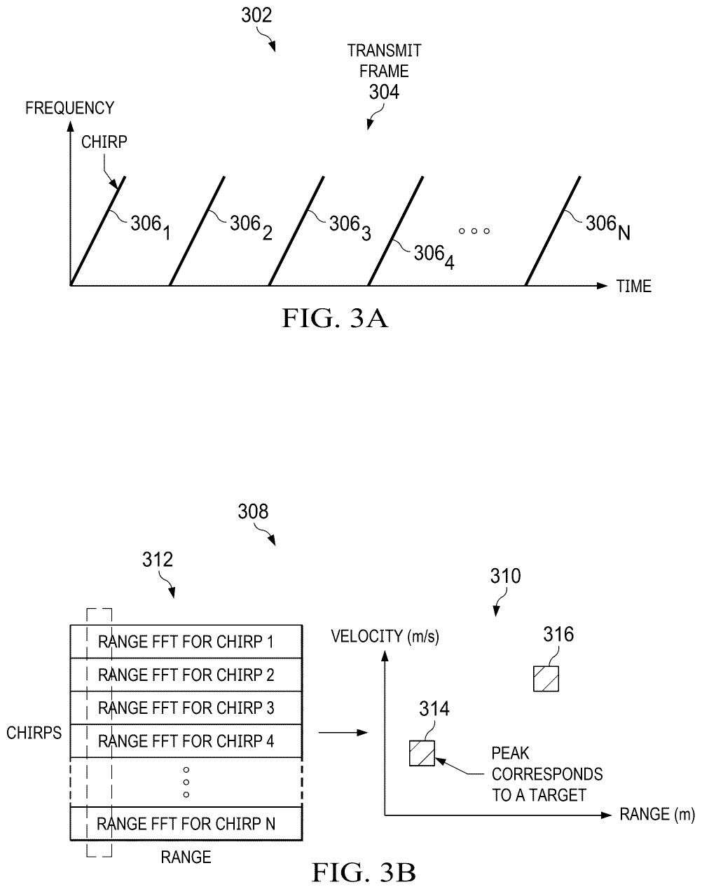

FIG. 3A is a timing diagram 302 of an example frame 304 of example chirps 306₁-306_{N}. In the example of FIG. 3A, the timing diagram 302 depicts frequency versus time. As illustrated in FIG. 3A, a chirp is a signal where the frequency of the signal varies linearly with time. In the example of FIG. 3A, the frame 304 refers to a series of (e.g., N) chirps that are equidistantly spaced in time. As such, in some examples, the frame 304 is referred to as a FMCW frame. In the example of FIG. 3A, the frame 304 includes a linear increment (or decrement) in phase of each chirp of the frame 304. As such, the phase change between consecutive chirps of the frame 304 is equal (e.g., ΔΦ_{C1-C2}=ΔΦ_{C2-C3}=ΔΦ_{C3-C4} . . . =ΔΦ_{C(N-1)-CN}). When the frame 304 of the chirps 306₁-306_{N} is transmitted into an environment and reflected off an object, a received frame may be processed according to a two-dimensional FFT and represented as a Doppler-range representation.

Returning to FIG. 2, the transmitters 204₁-204_{N} transmit frames of chirps simultaneously where each of the transmitters 204₁-204_{N} imparts a phase change (Φ) across the chirps of the frame as described above. In the example of FIG. 2, each of the LNAs 220₁-220_{M} is implemented by at least one of analog or digital circuitry. In the example of FIG. 2, the LNAs 220₁-220_{M} are coupled to the mixers 222₁-222_{M} and the receive antennas 208₁-208_{M}. Also, each of the mixers 222₁-222_{M} is implemented by at least one of analog or digital circuitry. In the example of FIG. 2, the mixers 222₁-222_{M} are coupled to the chirp synthesizer circuit 202, the LNAs 220₁-220_{M}, and the ADCs 224₁-224_{M}.

In the illustrated example of FIG. 2, each of the ADCs 224₁-224_{M} is implemented by at least one of analog or digital circuitry. In the example of FIG. 2, the ADCs 224₁-224_{M} are coupled to the mixers 222₁-222_{M} and the interface circuitry 212. Also, the interface circuitry 212 is implemented by at least one of analog or digital circuitry. For example, the interface circuitry 212 is implemented according to a communication technique such as a serial interface (e.g., SPI, LVDS interface, etc.), a parallel interface, etc. and is structured to facilitate communication according to the communication technique. In the example of FIG. 2, the interface circuitry 212 is coupled to the ADCs 224₁-224_{M} and the processor circuit 214.

In the illustrated example of FIG. 2, the processor circuit 214 is coupled to the interface circuitry 212. In some examples, the processor circuit 214 is coupled to the chirp synthesizer circuit 202. In the example of FIG. 2, the processor circuit 214 is implemented by at least one of analog or digital circuitry. For example, the processor circuit 214 may be implemented by a DSP, a microcontroller, an FFT engine, a combined DSP and microcontroller processor, an FPGA, or an application specific integrated circuit (ASIC).

In the illustrated example of FIG. 2, the processor circuit 214 may be instantiated (e.g., creating an instance of, bring into being for any length of time, materialize, implement, etc.) by programmable circuitry (e.g., at least one programmable circuit) such as a Central Processor Unit (CPU) executing first instructions, an FPGA, a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc. Also or alternatively, the processor circuit 214 of FIG. 2 may be instantiated (e.g., creating an instance of, bring into being for any length of time, materialize, implement, etc.) by (i) an ASIC or (ii) an FPGA structured or configured in response to execution of second instructions to perform operations corresponding to the first instructions. Some or all of the processor circuit 214 may, thus, be instantiated at the same or different times. Some or all of the processor circuit 214 may be instantiated, for example, in one or more threads executing concurrently on hardware or in series on hardware. Moreover, in some examples, some or all of the processor circuit 214 may be implemented by microprocessor circuitry executing instructions or FPGA circuitry performing operations to implement one or more virtual machines or containers.

In the illustrated example of FIG. 2, each of the receive antennas 208₁-208_{M} receives signals reflected from an environment in a field of view of the radar transceiver IC 200. For example, each of the receive antennas 208₁-208_{M} receives frames of reflected chirps from the environment. Because the frames of chirps are reflected from the environment, there is a time delay or phase shift between the transmitted frame of chirps and the reflected frame of chirps. In the example of FIG. 2, each of the LNAs 220₁-220_{M} amplifies the received frames of reflected chirps and forwards the amplified received frames to the mixers 222₁-222_{M}. In the example of FIG. 2, each of the mixers 222₁-222_{M} mixes the amplified received frames with the frame of chirps provided by the chirp synthesizer circuit 202 to produce IF received frames of reflected chirps. Also, each of the ADCs 224₁-224_{M} samples the IF received frames of reflected chirps to generate digital samples of the analog signals.

In the illustrated example of FIG. 2, the interface circuitry 212 receives digital samples from the ADCs 224₁-224_{M} and forwards the digital samples to the processor circuit 214 for processing. In the example of FIG. 2, the radar transceiver IC 200 has an R_{MAX} specification where R_{MAX} refers to a maximum range at which the radar transceiver IC 200 can detect a target. The radar transceiver IC 200 implements IF filtering to filter out reflected signals with a delay greater than τ_{MAX} where τ_{MAX} is equal to two R_{MAX} divided by the speed of light (τ_{MAX}=2*R_{MAX}/c). IF filtering ensures that the signal has a reduced or the minimum bandwidth while allowing signals from targets of interest to be detected and thus helps in minimizing the ADC sampling rate. IF filtering also helps in minimizing interference from other radars.

In some examples, the radar transceiver IC 200 includes digital front end (DFE) circuitry between the ADCs 224₁-224_{M} and the interface circuitry 212. For example, the DFE circuitry receives IF signals from the receivers 210₁-210_{M} and performs decimation filtering or other processing operations on the digital IF signals, for example, to reduce the data transfer rate of the digital IF signals. Also or alternatively, the DFE circuitry performs other operations on the digital IF signals such as direct current (DC) offset removal or compensation (e.g., digital compensation) of non-idealities in the receivers 210₁-210_{M} such as inter-receiver gain imbalance non-ideality, inter-receiver phase imbalance non-ideality, and the like.

In the illustrated example of FIG. 2, the processor circuit 214 receives digital samples representative of a frame of reflected chirps from the interface circuitry 212. In the example of FIG. 2, the processor circuit 214 is structured to perform at least a portion of signal processing on the digital IF signals resulting from a received radar frame. In some examples, the processor circuit 214 is structured to transmit the results of signal processing. For example, the processor circuit 214 transmits the results of signal processing to a processing unit (e.g., the processor circuit 104).

In the illustrated example of FIG. 2, the processor circuit 214 includes functionality to perform a range FFT on each received frame of reflected chirps. For example, the position of signal power peaks across the range dimension of a range FFT directly corresponds to the distance of a target from the radar transceiver IC 200. In the example of FIG. 2, the processor circuit 214 also includes functionality to perform a Doppler FFT on results of range FFTs. In some examples, the processor circuit 214 receives control information (e.g., timing of chirps, power level, triggering of monitoring functions, etc.) via an SPI bus. For example, based on the control information, the processor circuit 214 provides data parameters or provides control signals to the chirp synthesizer circuit 202.

FIG. 3B is a diagram of an example processing flow 308 to generate an example Doppler-range representation 310 of a received frame of reflected chirps. For example, the processing flow 308 to generate the Doppler-range representation 310 (sometimes referred to as a Doppler-range heatmap) includes the processor circuit 214 processing digital samples representative of a received frame of reflected chirps to generate an example matrix 312 of range FFTs. In the example of FIG. 3B, rows of the matrix 312 correspond to range FFTs of respective chirps in the received frame of reflected chirps and columns of the matrix 312 correspond to the range dimension of the range FFTs. In this manner, targets captured in the received frame of reflected chirps are separated by range.

In the illustrated example of FIG. 3B, by processing the range FFT representation of the received frame of reflected chirps (e.g., the matrix 312) across the range dimension (e.g., columns of the matrix 312), the processor circuit 214 generates the Doppler-range representation 310. For example, the processor circuit 214 performs an FFT (e.g., a Doppler FFT) across the range-dimension of the range FFT representation. In this manner, targets captured in the received frame of reflected chirps are separated by velocity. Thus, the Doppler-range representation 310 of the received frame of reflected chirps resolves targets in both the range and Doppler (e.g., velocity) dimensions.

In the illustrated example of FIG. 3B, the Doppler-range representation 310 is a three-dimensional graph that depicts range in meters (m) versus velocity in meters per second (m/s) where signals in the two-dimensional range-velocity field have an associated magnitude providing a third dimension. Signal peaks in the Doppler-range representation 310 correspond to targets in a field of view of the radar transceiver IC 200. For example, the Doppler-range representation 310 includes a first example representation 314 of a first object in a field of view of the radar transceiver IC 200 and a second example representation 316 of a second object in a field of view of the radar transceiver IC 200. For the sake of simplicity, the Doppler-range representation 310 corresponds to an implementation of the radar transceiver IC 200 with a single transmitter (e.g., the first indexed transmitter 204₁) with no DDMA modulation. For example, the Doppler-range representation 310 depicts the first representation 314 of a first object and the second representation 316 of the second object. In the case of DDMA modulation, the Doppler-range representation 310 would include N instances of the first object and the second object with Doppler offsets corresponding to the imparted phase shifts on the transmitters 204₁-204_{N}.

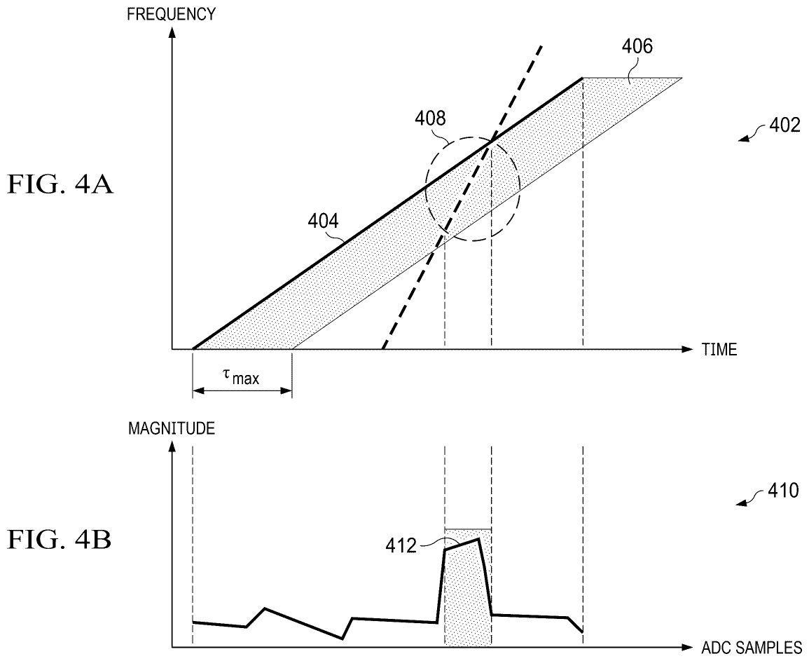

FIG. 4A is a timing diagram 402 of interference that can occur in radar applications. The timing diagram 402 represents interference in detection of an example chirp 404. In the example of FIG. 4A, the timing diagram 402 depicts frequency versus time. As illustrated in FIG. 4A, the chirp 404 is a signal where the frequency of the signal varies linearly with time. In the example of FIG. 4A, an example delay window 406 (e.g., represented by τ_{MAX}) around the chirp 404 represents signals that are in-band with the chirp 404. For example, the delay window 406 corresponds to a few 10's of megahertz (MHz) difference in frequency with respect to the frequency of the chirp 404 at a given instant of time.

Based on down conversion and low-pass filtering (e.g., performed by the radar transceiver IC 200), only portions of a signal within the delay window 406 are in-band with the chirp 404. As such, only portions of chirps that overlap the delay window 406 are in-band with the chirp 404. In the example of FIG. 4A, interference occurs whenever an example crossing chirp 408 is in-band with the chirp 404 (e.g., intersects the delay window 406). FIG. 4B is a graphical illustration 410 of digital samples corresponding to the timing diagram 402 of FIG. 4A. In the example of FIG. 4B, example digital samples 412 corresponding to the portion of the chirp 404 that overlaps with the crossing chirp 408 are corrupted. If the signal power of the crossing chirp 408 is larger than the signal power of the chirp 404 (e.g., several 10 s of decibels (dB) greater than that of the chirp 404), then the extent to which the digital samples 412 are corrupted increases.

In radar applications (e.g., an automotive application), interference from other radars can severely impair performance. As radar penetration and the level of automation increases, the extent to which interference between radars impairs performance will increase. To facilitate coexistence of multiple radars, radar interference is to be mitigated. Many studies have been conducted to explore interference mitigation techniques. These include the IMIKO project conducted by the Cooperation in Radar for Autonomous Electric Cars, the MOre Safety for All by Radar Interference Mitigation (MOSARIM) project conducted in the European Union, and radar interference studies conducted by the National Highway Traffic Safety Administration (NHTSA) in the United States.

In general, techniques to mitigate interference include detection and reconstruction. Detection includes detecting digital samples that are corrupted by interference. Many detection techniques are possible. One example detection technique includes computing the average magnitude of the digital samples in a chirp and identifying samples that are more than a threshold above the average magnitude as corrupted samples. Reconstruction includes reconstructing corrupted digital samples Reconstruction can reduce interference induced artefacts in the Doppler-range representations (e.g., heatmaps). One reconstruction technique includes setting corrupted digital samples of a chirp to zero, performing a range FFT on the digital samples including the zero-valued samples, and identifying a peak value in the range FFT. The range FFT is a matrix of complex numbers. As such, the peak value in the range FFT corresponds to the maximum value of the absolute value of the range FFT.

Based on the peak value, the reconstruction technique includes setting values in the range FFT that are outside of a threshold of the peak value to zero and performing an inverse range FFT to generate reconstructed digital samples. For example, the reconstruction technique includes setting values in the range FFT that are more than the threshold below the peak value to zero. After the reconstructed digital samples are generated, the reconstruction technique includes replacing the corrupted digital samples with the reconstructed digital samples. The above-described reconstruction technique can be used for all chirps of a frame of chirps to generate a frame of chirps including reconstructed samples. After samples are reconstructed for all chirps of a frame, a signal processor can perform a range FFT on the frame of chirps including the reconstructed samples and a Doppler FFT on the range FFT to generate a Doppler-range representation.

The above-described reconstruction technique mitigates interference resulting from interfering chirps that have a significantly different slope than a chirp being monitored (also referred to as a sweeping interferer). However, different types of interferers are possible. For example, the above-described reconstruction technique does not mitigate interference resulting from interfering chirps that have a similar slope to a chirp being monitored (also referred to as a parallel interferer). In examples described herein, the processor circuit 214 reduces interference artefacts in Doppler-range representations caused by sweeping interferers as well as parallel interferers. For example, the processor circuit 214 reconstructs chirps along the range dimension and along the Doppler dimension to generate a hybrid Doppler-range representation that improves the overall performance of the radar transceiver IC 200.

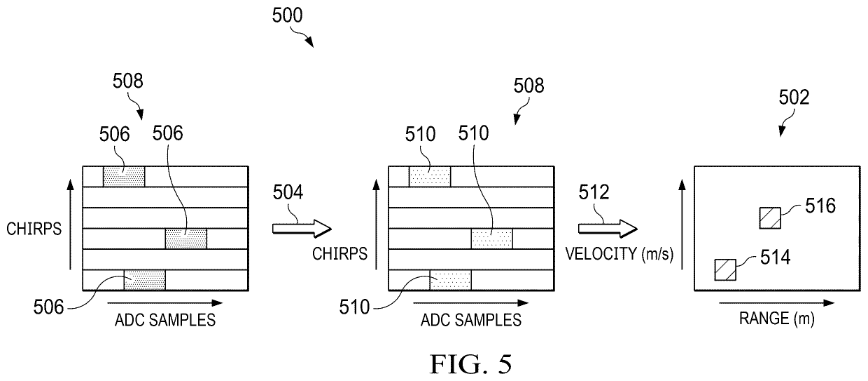

Returning to the illustrated example of FIG. 2, the processor circuit 214 generates two Doppler-range representations of a received frame of chirps and computes an element-wise minimum between the two Doppler-range representations to generate a resultant Doppler-range representation of the received frame of chirps that mitigates interference along the range dimension and the Doppler dimension. For example, the processor circuit 214 generates a first Doppler-range representation of a frame of chirps that mitigates interference along the range dimension and generates a second Doppler-range representation of the frame of chirps that mitigates interference along the Doppler dimension. FIG. 5 is a diagram of an example processing flow 500 to generate a first example Doppler-range representation 502 of a received frame of reflected chirps to mitigate interference along a range dimension.

In the illustrated example of FIG. 5, a first example process 504 includes the processor circuit 214 reconstructing corrupted digital samples based on a range FFT with values outside a threshold of a peak value set to zero. For example, the first process 504 includes the processor circuit 214 setting example corrupted ADC samples 506 of chirps in an example matrix 508 of chirp ADC samples to zero. For example, the corrupted ADC samples 506 are ADC samples of the matrix 508 that have been identified as being affected by interference (e.g., by a detection technique). In the example of FIG. 5, rows of the matrix 508 correspond to respective chirps in the received frame of reflected chirps and columns of the matrix 508 correspond to ADC samples in time.

In the illustrated example of FIG. 5, the first process 504 includes the processor circuit 214 performing a range FFT on the matrix 508 (with the zero-valued ADC samples), identifying a peak value in the range FFT representation of the matrix 508. In the example of FIG. 5, the range FFT representation of the matrix 508 is a matrix of complex numbers. As such, the first process 504 includes the processor circuit 214, for the purposes of identifying the peak value, converting the range FFT representation of the matrix 508 (e.g., by taking the absolute value) to a matrix of real, positive numbers. In the example of FIG. 5, the first process 504 also includes the processor circuit 214 setting values of the range FFT representation of the matrix 508 that do not satisfy a threshold of (e.g., more than a threshold below, more than a threshold above, etc.) the peak value to zero.

For example, the first process 504 includes the processor circuit 214 setting values of the range FFT representation of the matrix 508 that are more than the threshold below (e.g., do not satisfy) the peak value to zero. In the example of FIG. 5, the threshold is 3 dB. The first process 504 also includes the processor circuit 214 performing an inverse range FFT on the range FFT representation of the matrix 508 (with the zeroed values) to generate example reconstructed ADC samples 510 for the corrupted ADC samples 506. In the example of FIG. 5, first process 504 includes the processor circuit 214 replacing the corrupted ADC samples 506 in the matrix 508 with the reconstructed ADC samples 510.

In the illustrated example of FIG. 5, a second example process 512 includes the processor circuit 214 performing a range FFT on the matrix 508 (with the reconstructed ADC samples 510). In the example of FIG. 5, the second process 512 includes performing a Doppler FFT on the range FFT representation of the matrix 508 (with the reconstructed ADC samples 510) to generate the first Doppler-range representation 502. The first Doppler-range representation 502 is a three-dimensional graph that depicts range in m versus velocity in m/s where signals in the two-dimensional range-velocity field have an associated magnitude providing a third dimension. In general, the first Doppler-range representation 502 is a matrix of complex numbers. As such, the processor circuitry 214 may determine an absolute value of the first Doppler-range representation 502 to convert to magnitude before performing subsequent processing.

In the illustrated example of FIG. 5, the first Doppler-range representation 502 includes a first example representation 514 of a first object in a field of view of the radar transceiver IC 200 and a second example representation 516 of a second object in a field of view of the radar transceiver IC 200. For the sake of simplicity, the Doppler-range representation 502 corresponds to an implementation of the radar transceiver IC 200 with a single transmitter (e.g., the first indexed transmitter 204₁) with no DDMA modulation. For example, the Doppler-range representation 502 depicts the first representation 514 of the first object and the second representation 516 of the second object. In the case of DDMA modulation, the Doppler-range representation 502 would include N instances of the first object and the second object with Doppler offsets corresponding to the imparted phase shifts of the transmitters 204₁-204_{N}.

Also, the processing flow 500 corresponds to operations performed by the processor circuit 214 to generate the first Doppler-range representation 502 for a frame of reflected chirps received at a single receiver (e.g., the first indexed receiver 210₁). In reality, the processor circuit 214 performs the processing flow 500 for frames of reflected chirps received at each of the receivers 210₁-210_{M} of the radar transceiver IC 200 where the M Doppler-range representations include M instances of the first object and the second object. In such examples, the processor circuit 214 sums the first Doppler-range representation 502 for each of the receivers 210₁-210_{M} to generate a composite first Doppler-range representation.

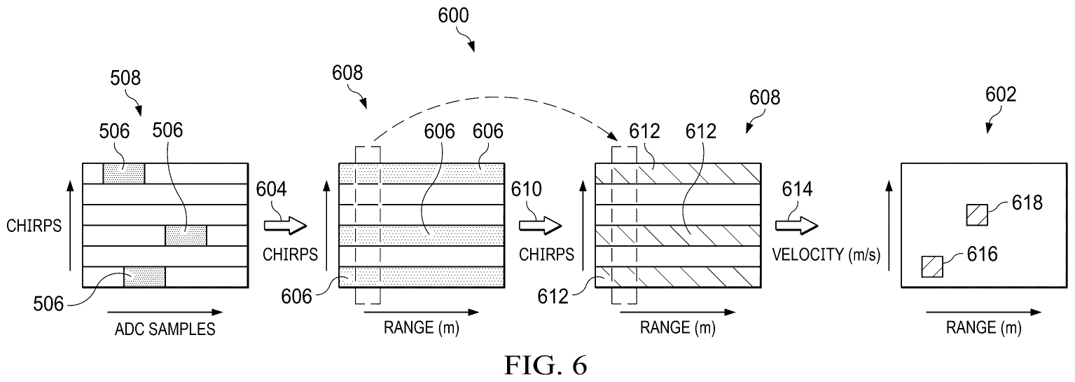

Returning to the illustrated example of FIG. 2, the processor circuit 214 generates a second Doppler-range representation of the frame of chirps that mitigates interference along the Doppler dimension. For example, FIG. 6 is a diagram of an example processing flow 600 to generate a second example Doppler-range representation 602 of the received frame of reflected chirps to mitigate interference along a Doppler dimension. In the example of FIG. 6, a first example process 604 includes the processor circuit 214 setting chirps of the matrix 508 that includes the corrupted ADC samples 506 to example zero-valued chirps 606. For example, the processor circuit 214 sets values of the rows of the matrix 508 that include the corrupted ADC samples 506 to zero to generate the zero-valued chirps 606.

In the illustrated example of FIG. 6, the first process 604 includes the processor circuit 214 performing a range FFT of the matrix 508 (with the zero-valued chirps 606) to generate an example range FFT representation 608 of the matrix 508. For example, the processor circuit 214 performs a range FFT on the non-zero chirps (e.g., the non-zero rows) of the matrix 508 to generate the range FFT representation 608. In the example of FIG. 6, a second example process 610 includes the processor circuit 214, for each column of the range FFT representation 608, performing a Doppler FFT and identifying a peak value in the Doppler FFT representation of each column of the range FFT representation 608. For example, the range FFT representation 608 and the Doppler FFT representation of each column thereof are matrices of complex numbers. As such, the second process 610 includes the processor circuit 214, for the purposes of identifying the peak value, converting at least one of the range FFT representation 608 or the Doppler FFT representation of each column thereof (e.g., by taking the absolute value) to at least one matrix of real, positive numbers.

In the illustrated example of FIG. 6, the second process 610 includes the processor circuit 214, for each column of the range FFT representation 608, setting values of the Doppler FFT representation of each column of the range FFT representation 608 that do not satisfy a threshold of (e.g., more than a threshold below, more than a threshold above, etc.) the peak value to zero. For example, the second process 610 includes the processor circuit 214, for each column of the range FFT representation 608, setting values of the Doppler FFT representation of each column of the range FFT representation 608 that are more than the threshold below (e.g., do not satisfy) the peak value to zero. In the example of FIG. 6, the threshold is 3 dB. The second process 610 also includes the processor circuit 214 performing an inverse Doppler FFT on the Doppler FFT representation of each column of the range FFT representation 608 to generate example reconstructed chirps 612 for the chirps of the matrix 508 that include the corrupted ADC samples 506. In the example of FIG. 6, the second process 610 includes the processor circuit 214 replacing the zero-valued chirps 606 of the range FFT representation 608 of the matrix 508 with the reconstructed chirps 612.

In the illustrated example of FIG. 6, a third example process 614 includes the processor circuit 214 performing a Doppler FFT on the range FFT representation 608 (with the reconstructed chirps 612) to generate the second Doppler-range representation 602. The second Doppler-range representation 602 is a three-dimensional graph that depicts range in m versus velocity in m/s where signals in the two-dimensional range-velocity field have an associated magnitude providing a third dimension. In general, the second Doppler-range representation 602 is a matrix of complex numbers. As such, the processor circuitry 214 may determine an absolute value of the second Doppler-range representation 602 to convert to magnitude before performing subsequent processing.

In the illustrated example of FIG. 6, the second Doppler-range representation 602 includes a first example representation 616 of a first object in a field of view of the radar transceiver IC 200 and a second example representation 618 of a second object in a field of view of the radar transceiver IC 200. For the sake of simplicity, the Doppler-range representation 602 corresponds to an implementation of the radar transceiver IC 200 with a single transmitter (e.g., the first indexed transmitter 204₁) with no DDMA modulation. For example, the Doppler-range representation 602 depicts the first representation 616 of the first object and the second representation 618 of the second object. In the case of DDMA modulation, the Doppler-range representation 602 would include N instances of the first object and the second object with Doppler offsets corresponding to the imparted phase shifts of the transmitters 204₁-204_{N}.

Also, the processing flow 600 corresponds to operations performed by the processor circuit 214 to generate the second Doppler-range representation 602 for a frame of reflected chirps received at a single receiver (e.g., the first indexed receiver 210₁). In reality, the processor circuit 214 performs the processing flow 600 for frames of reflected chirps received at each of the receivers 210₁-210_{M} of the radar transceiver IC 200 where the M Doppler-range representations include M instances of the first object and the second object. In such examples, the processor circuit 214 sums the second Doppler-range representation 602 for each of the receivers 210₁-210_{M} to generate a composite second Doppler-range representation.

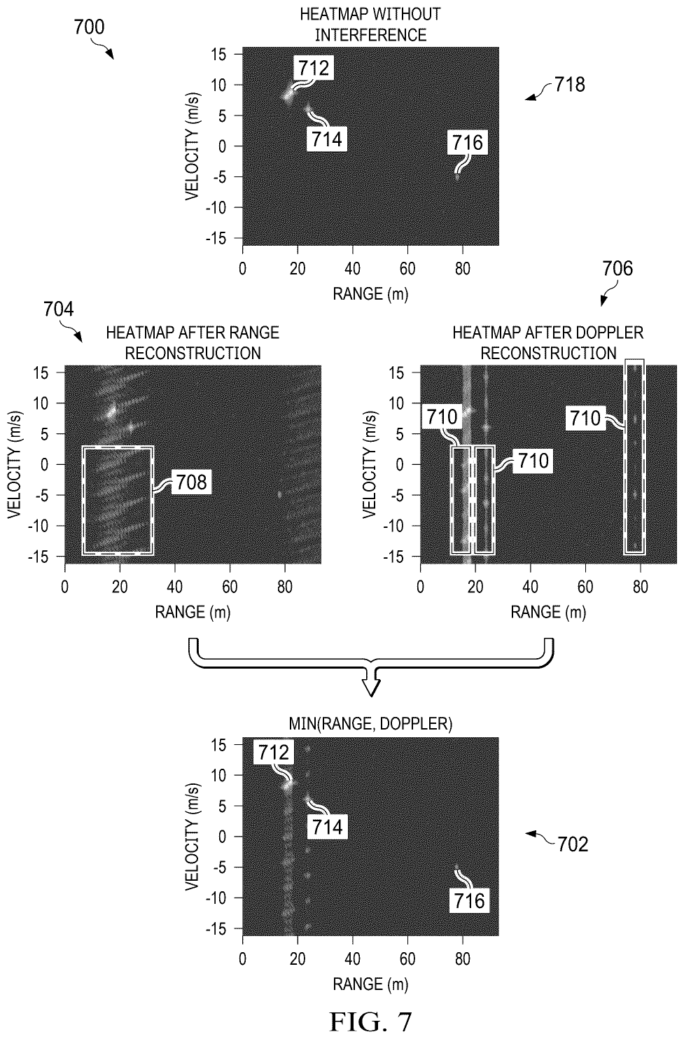

Returning to the illustrated example of FIG. 2, the processor circuit 214 generates a third Doppler-range representation as an element-wise minimum between a first Doppler-range representation of a frame of chirps that mitigates interference along the range dimension (e.g., the first Doppler-range representation 502) and a second Doppler-range representation of the frame of chirps that mitigates interference along the Doppler dimension (e.g., the second Doppler-range representation 602). For example, FIG. 7 is a diagram of an example processing flow 700 to generate a third example Doppler-range representation 702 of the received frame of reflected chirps to mitigate interference along the range dimension and the Doppler dimension. In the example of FIG. 7, the processor circuit 214 generates the third Doppler-range representation 702 by computing an element-wise minimum between a first example Doppler-range representation 704 and a second example Doppler-range representation 706.

In the illustrated example of FIG. 7, the first Doppler-range representation 704 is generated according to the processing flow 500 of FIG. 5. For example, the first Doppler-range representation 704 corresponds to the first Doppler-range representation 502 of FIG. 5. In the example of FIG. 7, the second Doppler-range representation 706 is generated according to the processing flow 600 of FIG. 6. For example, the second Doppler-range representation 706 corresponds to the second Doppler-range representation 602 of FIG. 6. As illustrated in FIG. 7, the first Doppler-range representation 704 includes first example interference artefacts 708 across range bins and the second Doppler-range representation 706 includes second example interference artefacts 710 across Doppler bins.

By computing the third Doppler-range representation 702 as an element-wise minimum between the first Doppler-range representation 704 and the second Doppler-range representation 706, the processor circuit 214 reduces the first interference artefacts 708 and the second interference artefacts 710. For example, the element-wise minimum between the first Doppler-range representation 704 and the second Doppler-range representation 706 does not retain the first interference artefacts 708 or the second interference artefacts 710. As such, based on the third Doppler-range representation 702, the processor circuit 214 can better detect a first example representation 712 of a first object, a second example representation 714 of a second object, and a third example representation 716 of a third object. Thus, the third Doppler-range representation 702 produced by the processor circuit 214 is a better approximation of an example ideal Doppler-range representation 718 of the received frame of reflected chirps than the first Doppler-range representation 704 or the second Doppler-range representation 706.

As described above, the Doppler-range representation 502 and the Doppler-range representation 602 correspond to implementations of the radar transceiver IC 200 with a single transmitter (e.g., the first indexed transmitter 204₁) with no DDMA modulation. In the case of DDMA modulation, the Doppler-range representation 502 and the Doppler-range representation 602 would include N instances of the first object, the second object, and the third object with Doppler offsets corresponding to the imparted phase shifts of the transmitters 204₁-204_{N}. Also, in reality, the processor circuit 214 performs the processing flow 500 and the processing flow 600 for frames of reflected chirps received at the radar transceiver IC 200. In reality, the processor circuit 214 sums the first Doppler-range representation 502 for each of the receivers 210₁-210_{M} to generate a composite first Doppler-range representation. Also, in reality, the processor circuit 214 sums the second Doppler-range representation 602 for each of the receivers 210₁-210_{M} to generate a composite second Doppler-range representation. In reality, when performing the processing flow 700, the processor circuit 214 generates the third Doppler-range representation 702 as an element-wise minimum between the composite first Doppler-range representation and the composite second Doppler-range representation.

Returning to the illustrated example of FIG. 2, by generating the first Doppler-range representation 502 and the second Doppler-range representation 602 as described above, the processor circuit 214 improves dynamic range for range bins and the dynamic range for Doppler bins of the Doppler-range representations. For example, by generating the first Doppler-range representation 502 as described above, the processor circuit 214 improves dynamic range for individual range bins of the first Doppler-range representation 502. Also, by generating the second Doppler-range representation 602 as described above, the processor circuit 214 improves dynamic range for individual Doppler bins of the second Doppler-range representation 602. As such, by generating the third Doppler-range representation 702 as described above (e.g., performing reconstruction along the range dimension and the Doppler dimension), the processor circuit 214 improves overall performance of the radar transceiver IC 200.

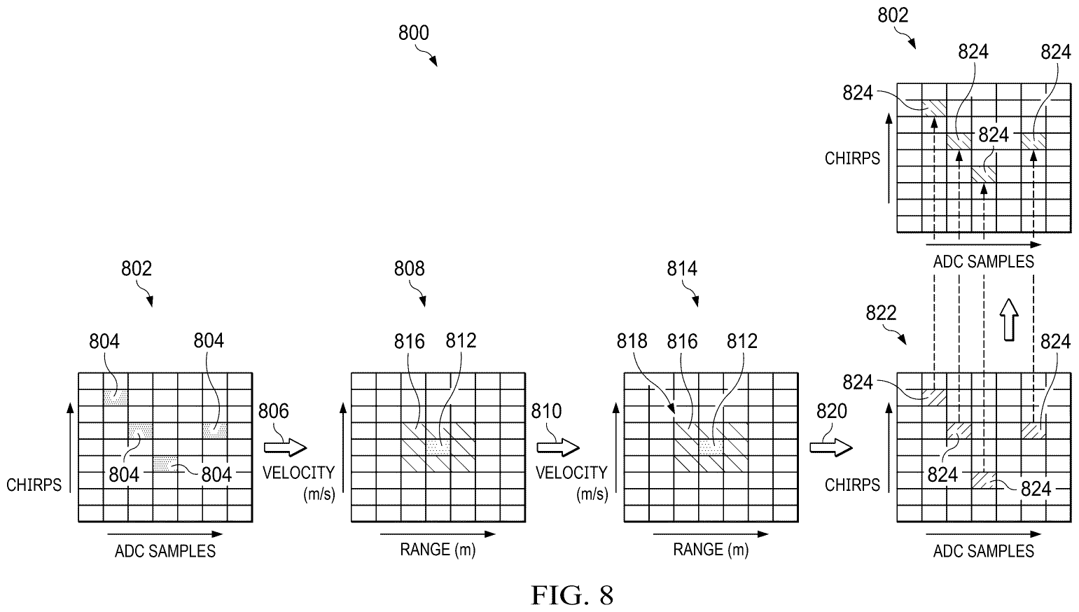

In the illustrated example of FIG. 2, the processor circuit 214 also or alternatively performs a process to reconstruct corrupted ADC samples along the range dimension and along the Doppler dimension. For example, FIG. 8 is a diagram of an example processing flow 800 to reconstruct corrupted ADC samples along the range dimension and the Doppler dimension. In the example of FIG. 8, an example matrix 802 of chirp ADC samples includes example zero-value samples 804 corresponding to corrupted ADC samples. For example, the corrupted ADC samples arc ADC samples of the matrix 802 that have been identified as being effected by interference (e.g., by a detection technique).

In the illustrated example of FIG. 8, rows of the matrix 802 correspond to respective chirps in the received frame of reflected chirps and columns of the matrix 802 correspond to ADC samples in time. In the example of FIG. 8, a first example process 806 includes the processor circuit 214 performing a two-dimensional FFT on the matrix 802. For example, the processor circuit 214 performs a range FFT along rows of the matrix 802 and performs a Doppler FFT along columns of the range FFT representation of the matrix 802.

In the illustrated example of FIG. 8, the two-dimensional FFT representation of the matrix 802 is a complex matrix. As such, the processor circuit 214 converts the two-dimensional FFT representation of the matrix 802 to a real, positive matrix to generate an example Doppler-range representation 808. For example, the processor circuit 214 temporarily converts the two-dimensional FFT representation of the matrix 802 to a real, positive matrix for purposes of determining a peak value of the Doppler-range representation 808 as described below. For example, the processor circuit 214 converts the two-dimensional FFT representation of the matrix 802 to a real, positive matrix by taking the absolute value of the two-dimensional FFT representation of the matrix 802. In some examples, the processor circuit 214 converts the two-dimensional FFT representation of the matrix 802 to a real, positive matrix by taking the logarithm of the absolute value of the two-dimensional FFT representation of the matrix 802.

In the illustrated example of FIG. 8, based on the first process 806, the processor circuit 214 generates the Doppler-range representation 808 of the matrix 802. In the example of FIG. 8, a second example process 810 includes the processor circuit 214 identifying an example peak value 812 in the Doppler-range representation 808 (post conversion to a real, positive matrix). Also, the second process 810 includes the processor circuit 214 setting values of the Doppler-range representation 808 that do not satisfy a threshold of (e.g., more than a threshold below, more than a threshold above, etc.) the peak value 812 to zero. For example, the second process 810 includes the processor circuit 214 setting values of the Doppler-range representation 808 that are more than the threshold below (e.g., do not satisfy) the peak value 812 to zero. In the example of FIG. 8, the threshold is 6 dB.

In the illustrated example of FIG. 8, based on the second process 810, the processor circuit 214 generates an example zero-value Doppler-range representation 814. For example, the zero-value Doppler-range representation 814 includes the peak value 812, example satisfying values 816 that satisfy the threshold, and example zero-values 818 corresponding to values of the Doppler-range representation 808 that do not satisfy the threshold. In the example of FIG. 8, a third example process 820 includes the processor circuit 214 performing an inverse two-dimensional FFT on the zero-value Doppler-range representation 814.

For example, the processor circuit 214 performs an inverse Doppler FFT along columns of the zero-value Doppler-range representation 814 and performs an inverse range FFT along rows of zero-value Doppler-range representation 814 to generate an example matrix 822 of reconstructed chirp ADC samples. In the example of FIG. 8, the matrix 822 includes reconstructed ADC samples 824 corresponding to the zero-value samples 804 of the matrix 802. In the example of FIG. 8, a fourth example process 826 includes processor circuit 214 replacing the zero-value samples 804 in the matrix 802 with the reconstructed ADC samples 824. In this manner, corrupted ADC samples in the matrix 802 are replaced with the reconstructed ADC samples 824.

In the illustrated example of FIG. 8, the processor circuit 214 can perform a two-dimensional FFT on the matrix output from the processing flow 800. For example, the processor circuit 214 performs a range FFT on the matrix 802 (with the reconstructed ADC samples 824) and performs a Doppler FFT on the range FFT representation of the matrix 802 to generate a Doppler-range representation of the frame of reflected chirps. As illustrated in FIG. 8, the processing flow 800 reconstructs corrupted ADC samples along the range dimension and the Doppler dimension.

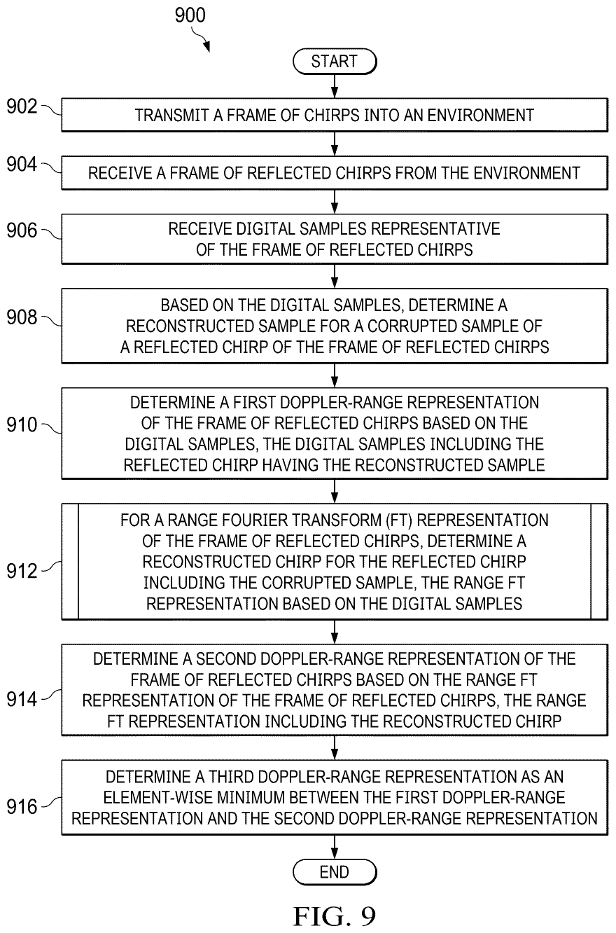

FIG. 9 is a flowchart representative of example machine-readable instructions or example operations 900 that may be at least one of executed, instantiated, or performed using an example programmable circuitry implementation of the radar transceiver IC 210 of FIG. 2 to determine a Doppler-range representation to mitigate interference along the range dimension and the Doppler dimension. The at least one of the example machine-readable instructions or the example operations 900 of FIG. 9 begin at block 902, at which at least one of the transmitters 204₁-204_{N} transmits a frame of chirps into an environment. For example, the first indexed transmitter 204₁ transmits a frame of chirps into the environment. In some examples, any number of the transmitters 204₁-204_{N} transmits a frame of chirps into the environment.

In the illustrated example of FIG. 9, at block 904, at least one of the receivers 210₁-210_{M} receives a frame of reflected chirps from the environment. For example, the first indexed receiver 210₁ receives a frame of reflected chirps from the environment. In some examples, any number of the receivers 210₁-210_{M} receives a frame of reflected chirps from the environment. In the example of FIG. 9, at block 906, the interface circuitry 212 receives digital samples representative of the frame of reflected chirps. For example, the interface circuitry 212 receives digital samples from the first indexed receiver 210₁. In some examples, the interface circuitry 212 receives digital samples from any number of the receivers 210₁-210_{M}.

In the illustrated example of FIG. 9, at block 908, based on the digital samples, the processor circuit 214 determines a reconstructed sample for a corrupted sample of a reflected chirp of the frame of reflected chirps. For example, for the reflected chirp, the processor circuit 214 sets the corrupted sample to zero, determines a range FT representation of the reflected chirp, and sets values in the range FT representation that do not satisfy (e.g., are outside of) a threshold of a peak value in the range FT representation to zero. For example, the range FT representation is a range FFT representation of the reflected chirp. In the example of FIG. 9, the range FT representation is a matrix of complex numbers. As such, the processor circuit 214 converts the range FT representation (e.g., by taking the absolute value) to a matrix of real, positive numbers before determining the peak value. In the example of FIG. 9, the processor circuit 214 sets values in the range FT representation with absolute values that are more than the threshold below (e.g., do not satisfy) the peak value to zero. Also, for example, the processor circuit 214 determines an inverse range FT representation of the range FT representation of the reflected chirp to generate the reconstructed sample.

Using the reconstructed sample, the processor circuit 214 replaces the corrupted sample in the reflected chirp with the reconstructed sample. In some examples, at block 908, the processor circuit 214 determines reconstructed samples for every corrupted sample in the frame of reflected chirps. For example, the processor circuit 214 determines reconstructed samples for every corrupted sample in the frame of reflected chirps according to the processing flow 500 of FIG. 5. In the example of FIG. 9, at block 910, the processor circuit 214 determines a first Doppler-range representation of the frame of reflected chirps based on the digital samples where the digital samples include the reflected chirp having the reconstructed sample. For example, the processor circuit 214 determines a range FT representation of the frame of reflected chirps based on the digital samples. Also, the processor circuit 214 determines a Doppler FT representation of the range FT representation to determine the first Doppler-range representation. For example, the Doppler FT representation is a Doppler FFT representation of the range FT representation.

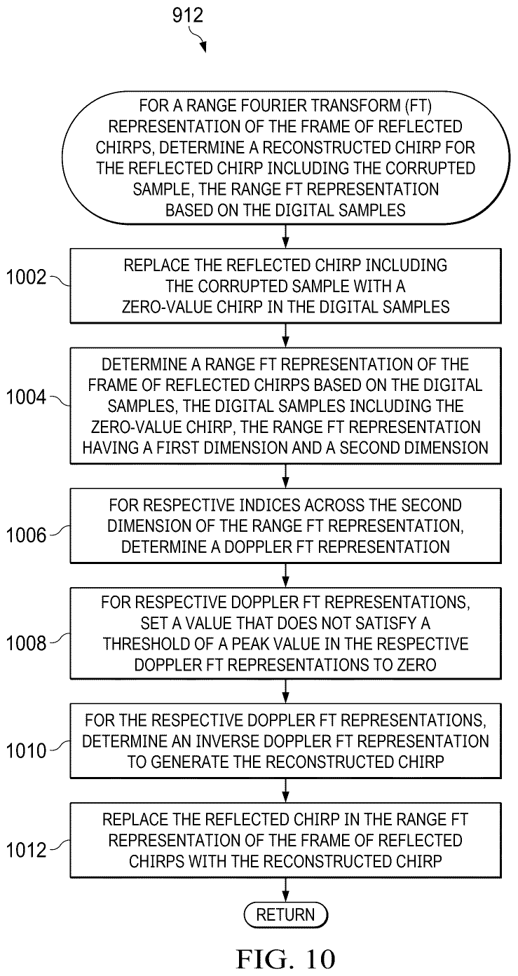

In the illustrated example of FIG. 9, at block 912, for a range FT representation of the frame of reflected chirps, the processor circuit 214 determines a reconstructed chirp for the reflected chirp including the corrupted sample where the range FT representation is based on the digital samples. In some examples, at block 912, the processor circuit 214 determines reconstructed chirps for every reflected chirp that includes a corrupted sample. For example, the processor circuit 214 determines reconstructed chirps for every reflected chirp that includes a corrupted sample according to the processing flow 600 of FIG. 6. At least one of example machine-readable instructions or example operations to implement block 912 are illustrated and described in connection with FIG. 10.

In the illustrated example of FIG. 9, at block 914, the processor circuit 214 determines a second Doppler-range representation of the frame of reflected chirps based on the range FT representation of the frame of reflected chirps. For example, the processor circuit 214 performs a Doppler FT along the range dimension (also referred to as range-bins) of the range FT representation of the frame of reflected chirps to determine the second Doppler-range representation. In the example of FIG. 9, the range FT representation includes the reconstructed chirp. At block 916, the processor circuit 214 determines a third Doppler-range representation as an element-wise minimum between the first Doppler-range representation and the second Doppler-range representation. As such, the third Doppler-range representation includes comparatively less interference artefacts than either the first Doppler-range representation or the second Doppler-range representation. Accordingly, subsequent processing based on the third Doppler-range representation will produce more accurate results.

FIG. 10 is a flowchart representative of example machine-readable instructions or example operations 912 that may be at least one of executed, instantiated, or performed using an example programmable circuitry implementation of the radar transceiver IC 200 of FIG. 2 to determine a reconstructed chirp for a reflected chirp including a corrupted sample. The at least one of the example machine-readable instructions or the example operations 912 of FIG. 10 begin at block 1002, at which the processor circuit 214 replaces the reflected chirp including the corrupted sample with a zero-value chirp in the digital samples. In other words, the zero-value chirp is substituted for the reflected chirp including the corrupted sample in the digital samples. In some examples, at block 1002, the processor circuit 214 replaces every reflected chirp that includes a corrupted sample with a zero-value chirp.

In the illustrated example of FIG. 10, at block 1004, the processor circuit 214 determines a range FT representation of the frame of reflected chirps based on the digital samples where the digital samples include the zero-value chirp. As described herein, the range FT representation has a first dimension (e.g., a height indicative of a number of rows) and a second dimension (e.g., a width indicative of a number of columns). In the example of FIG. 10, at block 1006, for respective indices across the second dimension of the range FT representation, the processor circuit 214 determines a Doppler FT representation. For example, the processor circuit 214 determines a Doppler FT representation for each column of the range FT representation.

In the illustrated example of FIG. 10, the range FT representation and the Doppler FT representation of each column thereof are matrices of complex numbers. As such, the processor circuit 214 converts at least one of the range FT representation or the Doppler FT representation of each column thereof (e.g., by taking the absolute value) to at least one matrix of real, positive numbers before determining the peak value. In the example of FIG. 10, at block 1008, for respective Doppler FT representations, the processor circuit 214 sets a value that does not satisfy a threshold of a peak value in the respective Doppler FT representations to zero. In the example of FIG. 10, for the respective Doppler FT representations, the processor circuit 214 sets a value that is more than the threshold below (e.g., does not satisfy) the peak value in the respective Doppler FT representations to zero. In some examples, at block 1008, the processor circuit 214 sets all values that do not satisfy the threshold to zero.

In the illustrated example of FIG. 10, at block 1010, for respective Doppler FT representations, the processor circuit 214 determines an inverse Doppler FT representation to generate the reconstructed chirp. At block 1012, the processor circuit 214 replaces the reflected chirp in the range FT representation of the frame of reflected chirps with the reconstructed chirp. For example, the processor circuit 214 replaces the reflected chirp that includes the corrupted sample with the reconstructed chirp. In other words, the reconstructed chirp is substituted for the reflected chirp including the corrupted sample of the chirp in the range FT representation. In some examples, at block 1012, the processor circuit 214 replaces all reflected chirps that include a corrupted sample with reconstructed chirps. After block 1012, the at least one of the example machine-readable instructions or the example operations 912 return to the at least one of the example machine-readable instructions or the example operations 1000 at block 914.

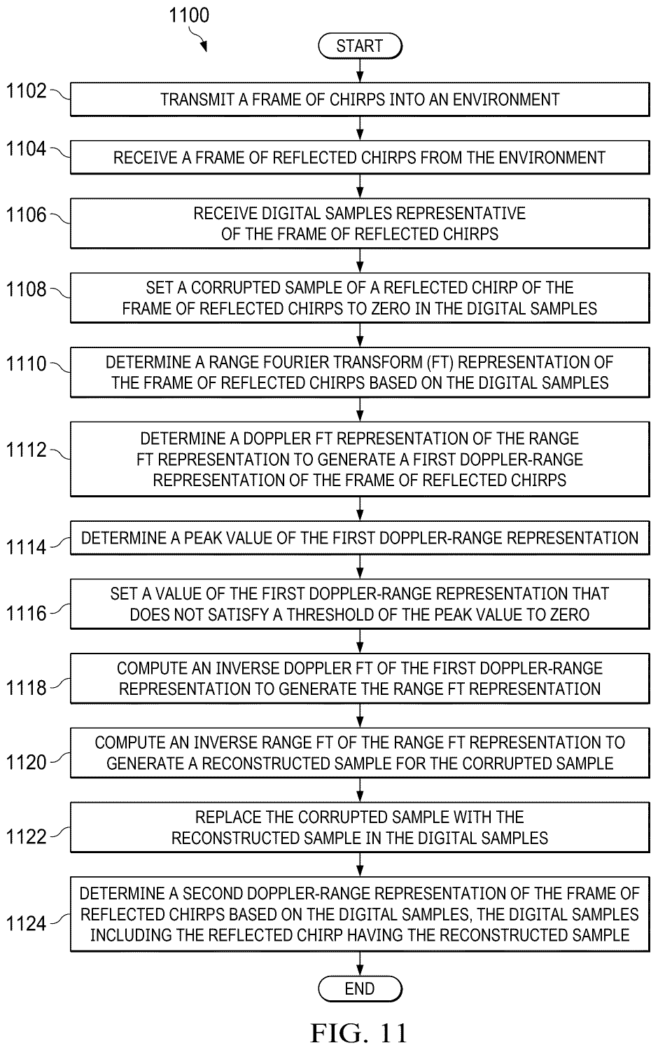

FIG. 11 is a flowchart representative of example machine-readable instructions or example operations 1100 that may be at least one of executed, instantiated, or performed using an example programmable circuitry implementation of the radar transceiver IC 200 of FIG. 2 to determine a Doppler-range representation to mitigate interference along the range dimension and the Doppler dimension. The at least one of the example machine-readable instructions or the example operations 1100 of FIG. 11 begin at block 1102, at which at least one of the transmitters 204₁-204_{N} (transmitter circuitry) transmits a frame of chirps into an environment. For example, the first indexed transmitter 204₁ transmits a frame of chirps into the environment. In some examples, any number of the transmitters 204₁-204_{N} transmits a frame of chirps into the environment.

In the illustrated example of FIG. 11, at block 1104, at least one of the receivers 210₁-210_{M} (receiver circuitry) receives a frame of reflected chirps from the environment. For example, a first example indexed receiver 210₁ receives a frame of reflected chirps from the environment. In some examples, any number of the receivers 210₁-210_{M} receives a frame of reflected chirps from the environment. In the example of FIG. 11, at block 1106, the interface circuitry 212 receives digital samples representative of the frame of reflected chirps. For example, the interface circuitry 212 receives digital samples from the first indexed receiver 210₁. In some examples, the interface circuitry 212 receives digital samples from any number of the receivers 210₁-210_{M}. In the example of FIG. 11, at block 1108, the processor circuit 214 sets a corrupted sample of a reflected chirp of the frame of reflected chirps to zero in the digital samples. In some examples, the processor circuit 214 sets all corrupted samples in the frame of reflected chirps to zero in the digital samples.

In the illustrated example of FIG. 11, at block 1110, the processor circuit 214 determines a range FT representation of the frame of reflected chirps based on the digital samples. In the example of FIG. 11, at block 1112, the processor circuit 214 determines a Doppler FT representation of the range FT representation to generate a first Doppler-range representation of the frame of reflected chirps. At block 1114, the processor circuit 214 determines a peak value of the first Doppler-range representation. In the example of FIG. 11, the first Doppler-range representation is a matrix of complex numbers. As such, the processor circuit 214 converts the first Doppler-range representation (e.g., by taking the absolute value) to a matrix of real, positive numbers before determining the peak value.

In the illustrated example of FIG. 11, at block 1116, the processor circuit 214 sets a value of the first Doppler-range representation with an absolute value that does not satisfy a threshold of the peak value to zero. In the example of FIG. 11, the processor circuit 214 sets a value in the first Doppler-range representation that is more than the threshold below (e.g., does not satisfy) the peak value in the first Doppler-range representation to zero. In some examples, the processor circuit 214 sets all values of the first Doppler-range representation that do not satisfy the threshold to zero.

In the illustrated example of FIG. 11, at block 1118, the processor circuit 214 computes an inverse Doppler FT of the first Doppler-range representation to generate the range FT representation. At block 1120, the processor circuit 214 computes an inverse range FT of the range FT representation to generate a reconstructed sample for the corrupted sample. In some examples, the processor circuit 214 computes an inverse Doppler FT and an inverse range FT to generate reconstructed samples for all corrupted samples of the frame of reflected chirps. At block 1122, the processor circuit 214 replaces the corrupted sample with the reconstructed sample in the digital samples. In other words, the reconstructed sample is substituted for the corrupted sample of the chirp in the digital samples. In some examples, the processor circuit 214 replaces all corrupted samples with a reconstructed sample.

In the illustrated example of FIG. 11, at block 1124, the processor circuit 214 determines a second Doppler-range representation of the frame of reflected chirps based on the digital samples where the digital samples include the reflected chirp having the reconstructed sample. For example, the processor circuit 214 determines a range FT representation of the frame of reflected chirps based on the digital samples. Also, for example, the processor circuit 214 determines a Doppler FT representation of the range FT representation to generate the second Doppler-range representation of the frame of reflected chirps.

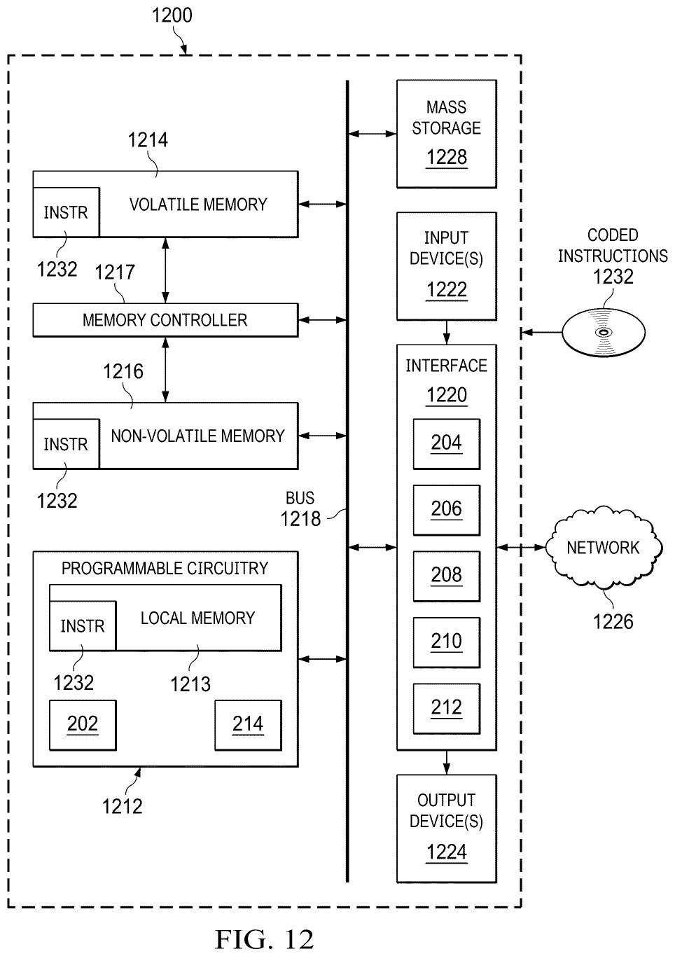

FIG. 12 is a block diagram of an example programmable circuitry platform 1200 structured to one or a combination of execute or instantiate one or more of the example machine-readable instructions or the example operations of FIGS. 9, 10, and 11 to implement the radar transceiver IC 200 of FIG. 2. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, or microcontrollers from any desired family or manufacturer. The programmable circuitry 1212 may be implemented by one or more semiconductor based (e.g., silicon based) devices. In this example, the programmable circuitry 1212 implements the example chirp synthesizer circuit 202 and the example processor circuit 214.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1216 may be implemented by one or a combination of flash memory or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter one of or a combination of data or commands into the programmable circuitry 1212. The input device(s) 1222 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1224 are also connected to the interface circuitry 1220 of the illustrated example. The output device(s) 1224 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1220 of the illustrated example, thus, includes one of or a combination of a graphics driver card, a graphics driver chip, or graphics processor circuitry such as a GPU.

The interface circuitry 1220 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 1220 implements the example transmitters 204₁-204_{N}, the example transmit antennas 206₁-206_{N}, the example receive antennas 208₁-208_{M}, the example receivers 210₁-210_{M}, and the example interface circuitry 212.

The programmable circuitry platform 1200 of the illustrated example also includes one or more mass storage discs or devices 1228 to store one or more of firmware, software, or data. Examples of such mass storage discs or devices 1228 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1232, which may be implemented by the machine-readable instructions of FIGS. 9, 10, and 11, may be stored in one of or a combination of the mass storage device 1228, in the volatile memory 1214, in the non-volatile memory 1216, or on at least one non-transitory computer-readable storage medium such as a CD or DVD which may be removable.

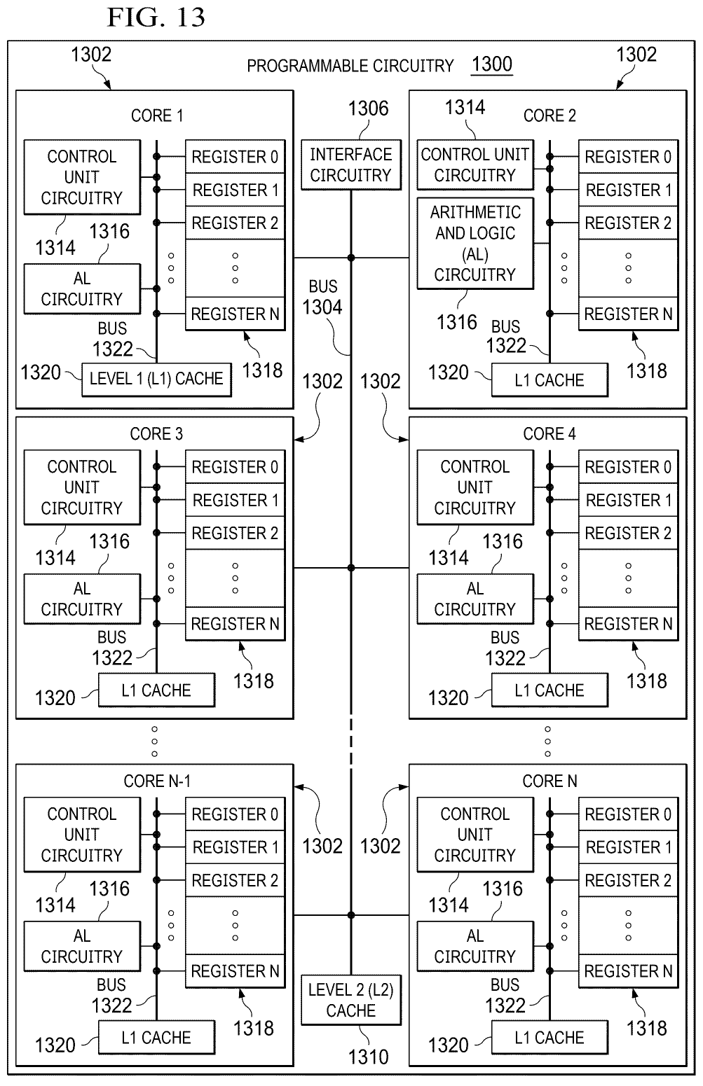

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 9, 10, and 11 to effectively instantiate the circuitry of FIG. 2 as logic circuits to perform operations corresponding to those machine-readable instructions. In some such examples, the circuitry of FIG. 2 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine-readable instructions or operations represented by the flowcharts of FIGS. 9, 10, and 11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Also or alternatively, the first bus 1304 may be implemented by any other type of computing or electrical bus. The cores 1302 may obtain data, instructions, and signals from one or more external devices by example interface circuitry 1306. The cores 1302 may output data, instructions, and signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and instructions. Data and instructions may be transferred (e.g., shared) by one of or a combination of writing to or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry 1316 (sometimes referred to as an ALU), a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic or logic operations on the data within the corresponding core 1302. The AL circuitry 1316 of some examples performs integer-based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 or, more generally, the microprocessor 1300 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 1300 is a semiconductor device fabricated to include many transistors interconnected to implement the structures described above in one or more integrated circuits (ICs) contained in one or more packages.

The microprocessor 1300 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those described herein. A GPU, DSP, or other programmable device can also be an accelerator. Accelerators may be on-board the microprocessor 1300, in the same chip package as the microprocessor 1300, or in one or more separate packages from the microprocessor 1300.

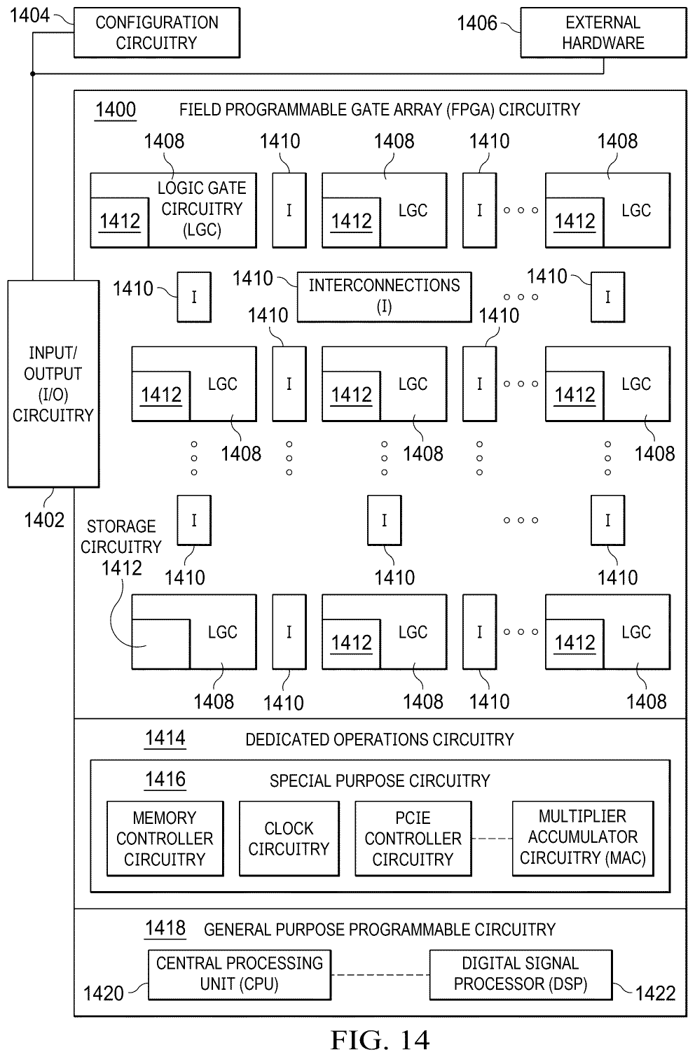

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine-readable instructions. However, once configured, the FPGA circuitry 1400 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine-readable instructions represented by the flowchart(s) of FIGS. 9, 10, and 11 but whose interconnections and logic circuitry are fixed once fabricated), the FPGA circuitry 1400 of the example of FIG. 14 includes interconnections and logic circuitry that may be one of or a combination of configured, structured, programmed, and interconnected in different ways after fabrication to instantiate, for example, some or all of the operations/functions corresponding to the machine-readable instructions represented by the flowchart(s) of FIGS. 9, 10, and 11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., at least one of the software or firmware) represented by the flowchart(s) of FIGS. 9, 10, and 11. As such, the FPGA circuitry 1400 may be at least one of configured or structured to effectively instantiate some or all of the operations/functions corresponding to the machine-readable instructions of the flowchart(s) of FIGS. 9, 10, and 11 as dedicated logic circuits to perform the operations/functions corresponding to those software instructions in a dedicated manner analogous to an ASIC. Therefore, the FPGA circuitry 1400 may perform the operations/functions corresponding to the some or all of the machine-readable instructions of FIGS. 9, 10, and 11 faster than the general-purpose microprocessor can execute the same.

In the example of FIG. 14, the FPGA circuitry 1400 is at least one of configured or structured in response to being programmed (or reprogrammed one or more times) based on a binary file. In some examples, the binary file may be one of or both of compiled or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may at least one of access or load the binary file to cause the FPGA circuitry 1400 of FIG. 14 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1400 of FIG. 14 to at least one of configure or structure the FPGA circuitry 1400 of FIG. 14, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 1400 of FIG. 14 may at least one of access or load the binary file to cause the FPGA circuitry 1400 of FIG. 14 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1400 of FIG. 14 to at least one of configure or structure the FPGA circuitry 1400 of FIG. 14, or portion(s) thereof.

The FPGA circuitry 1400 of FIG. 14, includes example input/output (I/O) circuitry 1402 to at least one of obtain or output data to/from at least one of example configuration circuitry 1404 or external hardware 1406. For example, the configuration circuitry 1404 may be implemented by interface circuitry that may obtain a binary file, which may be implemented by one or more of a bit stream, data, or machine-readable instructions, to configure the FPGA circuitry 1400, or portion(s) thereof. In some such examples, the configuration circuitry 1404 may obtain the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine-readable instructions of FIGS. 9, 10, and 11 or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of one of or a combination of the electrical structures or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 or an example DSP 1422. Other general purpose programmable circuitry 1418 may also or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may also be implemented by combining at least the example microprocessor 1300 of FIG. 13 and the example FPGA circuitry 1400 of FIG. 14. In some such hybrid examples, one or more cores 1302 of FIG. 13 may execute a first portion of the machine-readable instructions represented by the flowchart(s) of FIGS. 9, 10, and 11 to perform first operation(s)/function(s), the FPGA circuitry 1400 of FIG. 14 may be at least one of configured or structured to perform second operation(s)/function(s) corresponding to a second portion of the machine-readable instructions represented by the flowcharts of FIGS. 9, 10, and 11, or an ASIC may be at least one of configured or structured to perform third operation(s)/function(s) corresponding to a third portion of the machine-readable instructions represented by the flowcharts of FIGS. 9, 10, and 11.

Some or all of the circuitry of FIG. 2 may, thus, be instantiated at the same or different times. For example, same or different portion(s) of the microprocessor 1300 of FIG. 13 may be programmed to execute portion(s) of machine-readable instructions at the same or different times. In some examples, same or different portion(s) of the FPGA circuitry 1400 of FIG. 14 may be at least one of configured or structured to perform operations/functions corresponding to portion(s) of machine-readable instructions at the same or different times.

In some examples, some or all of the circuitry of FIG. 2 may be instantiated, for example, in one or more threads executing concurrently or in series. For example, the microprocessor 1300 of FIG. 13 may execute machine-readable instructions in one or more threads executing concurrently or in series. In some examples, the FPGA circuitry 1400 of FIG. 14 may be at least one of configured or structured to carry out operations/functions concurrently or in series. Moreover, in some examples, some or all of the circuitry of FIG. 2 may be implemented within one or more virtual machines or containers executing on the microprocessor 1300 of FIG. 13.

In some examples, the programmable circuitry 1212 of FIG. 12 may be in one or more packages. For example, at least one of the microprocessor 1300 of FIG. 13 or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

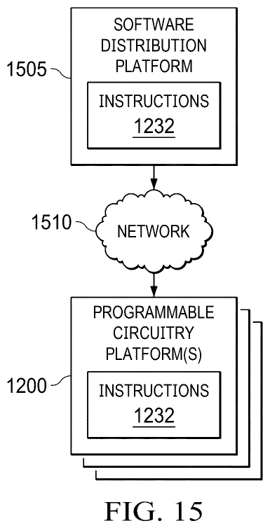

A block diagram illustrating an example software distribution platform 1505 to distribute software such as the example machine-readable instructions 1232 of FIG. 12 to other hardware devices (e.g., one or more hardware devices owned or operated by third parties from the owner or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity at least one of owning or operating the software distribution platform 1505. For example, the entity that at least one of owns or operates the software distribution platform 1505 may be at least one of a developer, a seller, or a licensor of software such as the example machine-readable instructions 1232 of FIG. 12. The third parties may be consumers, users, retailers, OEMs, etc., who one of or a combination of purchase or license the software for at least one of use, re-sale, or sub-licensing. In the illustrated example, the software distribution platform 1505 includes one or more servers and one or more storage devices. The storage devices store the machine-readable instructions 1232, which may correspond to the example machine-readable instructions of FIGS. 9, 10, and 11, as described above. The one or more servers of the example software distribution platform 1505 are in communication with an example network 1510, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third-party payment entity. The servers enable one or more purchasers or licensors to download the machine-readable instructions 1232 from the software distribution platform 1505. For example, the software, which may correspond to the example machine-readable instructions of FIGS. 9, 10, and 11, may be downloaded to the example programmable circuitry platform 1200, which is to execute the machine-readable instructions 1232 to implement the radar transceiver IC 200. In some examples, one or more servers of the software distribution platform 1505 periodically at least one of offer, transmit, or force updates to the software (e.g., the example machine-readable instructions 1232 of FIG. 12) to ensure improvements, patches, updates, etc., are distributed and applied to the software at the end user devices. Although referred to as software above, the distributed “software” could alternatively be firmware.

While an example manner of implementing the radar transceiver IC 200 of FIG. 2 is illustrated in FIG. 2, one or more of the elements, processes, or devices illustrated in FIG. 2 may be combined, divided, re-arranged, omitted, eliminated, or implemented in any other way. Further, the example chirp synthesizer circuit 202, the example transmitters 204₁-204_{N}, the example transmit antennas 206₁-206_{N}, the example receive antennas 208₁-208_{M}, the example receivers 210₁-210_{M}, the example interface circuitry 212, the example processor circuit 214, or, more generally, the example radar transceiver IC 200 of FIG. 2, may be implemented by hardware alone or by hardware in combination with software and firmware. Thus, for example, any of the example chirp synthesizer circuit 202, the example transmitters 204₁-204_{N}, the example transmit antennas 206₁-206_{N}, the example receive antennas 208₁-208_{M}, the example receivers 210₁-210_{M}, the example interface circuitry 212, the example processor circuit 214, or, more generally, the example radar transceiver IC 200, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example radar transceiver IC 200 of FIG. 2 may include one or more elements, processes, or devices in addition to, or instead of, those illustrated in FIG. 2, or may include more than one of any or all of the illustrated elements, processes, and devices.

Flowchart(s) representative of example machine-readable instructions, which may be executed by programmable circuitry to at least one of implement or instantiate the radar transceiver IC 200 of FIG. 2 or representative of example operations which may be performed by programmable circuitry to at least one of implement or instantiate the radar transceiver IC 200 of FIG. 2, are shown in FIGS. 9, 10, and 11. The machine-readable instructions may be one or more executable programs or portion(s) of one or more executable programs for execution by programmable circuitry such as the programmable circuitry 1212 shown in the example programmable circuitry platform 1200 described below in connection with FIG. 12 and may be one or more function(s) or portion(s) of functions to be performed by the example programmable circuitry (e.g., an FPGA) described below in connection with FIG. 13 or 14. In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more non-transitory computer-readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer-readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with at least one of a human user or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 9, 10, and 11, many other methods of implementing the example radar transceiver IC 200 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete analog circuitry, discrete digital circuitry, integrated analog circuitry, integrated digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include any combination of one or more CPUs and one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine-executable instructions. For example, the machine-readable instructions may be fragmented and stored on one or more storage devices, disks, or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, where the parts when decrypted, decompressed, or combined form a set of one or more computer-executable or machine-executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer-readable, or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9, 10, and 11 may be implemented using executable instructions (e.g., at least one of computer-readable or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer-readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer-readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer-readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the description (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Unless specifically stated to the contrary, terms such as node and interconnection may be used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as at least one of voltage sources or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Any value given herein is approximate, recognizing the potential presence of variations that occur in real world applications. A stated value may not be exact due to at least one of manufacturing tolerances or other real-world imperfections. Unless otherwise stated, a stated value means +/−10 percent of the stated value, or, if the value is zero, a reasonable range of values around zero.

Modifications are possible in the described examples, and other examples are possible, within the scope of the claims.

From the foregoing, it will be appreciated that example systems, apparatus, articles of manufacture, and methods have been described that improve dynamic range in the presence of interference. Described systems, apparatus, articles of manufacture, and methods improve the efficiency of using a computing device by reducing artefacts related to interference reconstruction. Reduction of artefacts related to interference reconstruction and directly results in a reduced tradeoff in higher-level functions (e.g., object tracking, etc.) and decreased detection of false targets. Accordingly, described systems, apparatus, articles of manufacture, and methods are directed to one or more improvement(s) in the operation of a machine such as a computer or other electronic, electromechanical, or mechanical device.

What is claimed is:

1. An apparatus comprising:
interface circuitry to receive digital samples representative of a frame of chirps; and
programmable circuitry to:
for a range Fourier transform (FT) representation of the frame of chirps, determine a reconstructed chirp for a chirp of the frame of chirps that includes a corrupted sample;
determine a first Doppler-range representation of the frame of chirps based on the range FT representation, the range FT representation including the reconstructed chirp; and
determine a second Doppler-range representation as an element-wise minimum between the first Doppler-range representation and a third Doppler-range representation of the frame of chirps, the third Doppler-range representation based on the digital samples, the digital samples including a reconstructed sample substituted for the corrupted sample of the chirp.

2. The apparatus of claim 1, including receiver circuitry to receive the frame of chirps from an environment.

3. The apparatus of claim 1, wherein the frame of chirps is a first frame of reflected chirps from an environment, and the apparatus includes transmitter circuitry to transmit a second frame of chirps into the environment.

4. The apparatus of claim 1, wherein the programmable circuitry is to:
based on the digital samples, determine the reconstructed sample for the corrupted sample; and
determine the third Doppler-range representation based on the digital samples, the digital samples including the chirp having the reconstructed sample.

5. The apparatus of claim 1, wherein the programmable circuitry is to:
replace the chirp including the corrupted sample with a zero-value chirp in the digital samples;
determine the range FT representation of the frame of chirps based on the digital samples, the digital samples including the zero-value chirp, the range FT representation having a first dimension and a second dimension;
for respective indices across the second dimension of the range FT representation, determine a Doppler FT representation;
for respective Doppler FT representations:
set a value that does not satisfy a threshold of a peak value in the respective Doppler FT representations to zero; and
determine an inverse range FT representation to generate the reconstructed chirp; and
replace the chirp including the corrupted sample in the range FT representation with the reconstructed chirp.

6. The apparatus of claim 1, wherein the programmable circuitry is to:
determine the range FT representation of the frame of chirps, the range FT representation including the reconstructed chirp; and
determine a Doppler FT representation of the range FT representation to determine the first Doppler-range representation.

7. The apparatus of claim 1, wherein the second Doppler-range representation determined as the element-wise minimum between the first Doppler-range representation and the third Doppler-range representation is to mitigate first interference in a range dimension and second interference in a Doppler dimension.

8. A non-transitory computer-readable medium comprising instructions to cause programmable circuitry to:
for a range Fourier transform (FT) representation of a frame of chirps, determine a reconstructed chirp for a chirp of the frame of chirps that includes a corrupted sample, the frame of chirps received from an environment by a radar integrated circuit and represented by digital samples;
determine a first Doppler-range representation of the frame of chirps based on the range FT representation, the range FT representation including the reconstructed chirp; and
determine a second Doppler-range representation as an element-wise minimum between the first Doppler-range representation and a third Doppler-range representation of the frame of chirps, the third Doppler-range representation based on the digital samples, the digital samples including a reconstructed sample substituted for the corrupted sample of the chirp.

9. The non-transitory computer-readable medium of claim 8, wherein the instructions cause the programmable circuitry to:
based on the digital samples, determine the reconstructed sample for the corrupted sample; and
determine the third Doppler-range representation based on the digital samples, the digital samples including the chirp having the reconstructed sample.

10. The non-transitory computer-readable medium of claim 8, wherein the instructions cause the programmable circuitry to:
replace the chirp including the corrupted sample with a zero-value chirp in the digital samples;
determine the range FT representation of the frame of chirps based on the digital samples, the digital samples including the zero-value chirp, the range FT representation having a first dimension and a second dimension;
for respective indices across the second dimension of the range FT representation, determine a Doppler FT representation;
for respective Doppler FT representations:
set a value that does not satisfy a threshold of a peak value in the respective Doppler FT representations to zero; and
determine an inverse range FT representation to generate the reconstructed chirp; and
replace the chirp including the corrupted sample in the range FT representation with the reconstructed chirp.

11. The non-transitory computer-readable medium of claim 8, wherein the instructions cause the programmable circuitry to:
determine the range FT representation of the frame of chirps, the range FT representation including the reconstructed chirp; and
determine a Doppler FT representation of the range FT representation to determine the first Doppler-range representation.

12. The non-transitory computer-readable medium of claim 8, wherein the second Doppler-range representation determined as the element-wise minimum between the first Doppler-range representation and the third Doppler-range representation is to mitigate first interference in a range dimension and second interference in a Doppler dimension.

13. The non-transitory computer-readable medium of claim 12, wherein mitigation of the first interference and the second interference is to improve a dynamic range of the radar integrated circuit.

14. A method comprising:
receiving, with interface circuitry, digital samples representative of a frame of chirps;
replacing, by executing an instruction with programmable circuitry, a chirp of the frame of chirps that includes a corrupted sample with a zero-value chirp in the digital samples;
determining, by executing an instruction with the programmable circuitry, a range Fourier transform (FT) representation of the frame of chirps based on the digital samples, the digital samples including the zero-value chirp, the range FT representation having a first dimension and a second dimension;
for respective indices across the second dimension of the range FT representation, determining, by executing an instructions with the programmable circuitry, a Doppler FT representation;
for respective Doppler FT representations:
setting, by executing an instruction with the programmable circuitry, a value that does not satisfy a threshold of a peak value in the respective Doppler FT representations to zero; and
determining, by executing an instruction with the programmable circuitry, an inverse range FT representation to generate a reconstructed chirp;
replacing, by executing an instruction with the programmable circuitry, the chirp including the corrupted sample in the range FT representation with the reconstructed chirp; and
determining, by executing an instruction with the programmable circuitry, a Doppler-range representation of the frame of chirps based on the range FT representation, the range FT representation including the reconstructed chirp.

15. The method of claim 14, wherein the Doppler-range representation is a first Doppler-range representation, and the method includes determining a second Doppler-range representation as an element-wise minimum between the first Doppler-range representation and a third Doppler-range representation of the frame of chirps, the third Doppler-range representation based on the digital samples, the digital samples including a reconstructed sample substituted for the corrupted sample of the chirp.

16. The method of claim 15, including:
based on the digital samples, determining the reconstructed sample for the corrupted sample; and
determining the third Doppler-range representation based on the digital samples, the digital samples including the chirp having the reconstructed sample.

17. The method of claim 15, wherein the second Doppler-range representation determined as the element-wise minimum between the first Doppler-range representation and the third Doppler-range representation is to mitigate first interference in a range dimension and second interference in a Doppler dimension.

18. The method of claim 14, including receiving, with receiver circuitry, the frame of chirps from an environment.

19. The method of claim 14, wherein the frame of chirps is a first frame of reflected chirps from an environment, and the method includes transmitting, with transmitter circuitry, a second frame of chirps into the environment.

20. The method of claim 14, wherein the Doppler FT representation is a first Doppler FT representation and the method includes:
determine the range FT representation of the frame of chirps, the range FT representation including the reconstructed chirp; and
determine a second Doppler FT representation of the range FT representation to determine the Doppler-range representation.
